(19) United States
(12) Patent Application Publication
(10) Pub. No.: US 2013/0224595 A1
(43) Pub. Date: Aug. 29, 2013

(54) CARBON COATED LITHIUM TRANSITION METAL PHOSPHATE AND PROCESS FOR ITS MANUFACTURE

(71) Applicants: Gerhard Nuspl, Munchen (DE); Christoph Stinner, Munchen (DE); Herr Holger Kunz, Landshut (DE); Guoxian Liang, Saint-Hyacinthe (CA)

(72) Inventors: Gerhard Nuspl, Munchen (DE); Christoph Stinner, Munchen (DE); Herr Holger Kunz, Landshut (DE); Guoxian Liang, Saint-Hyacinthe (CA)

(73) Assignee: SUD-CHEMIE IP GMBH & CO. KG, MUNCHEN (DE)

(21) Appl. No.: 13/812,321

(22) PCT Filed: Jul. 26, 2011
(86) PCT No.: PCT/EP2011/062843

§ 371 Date: May 13, 2013

Related U.S. Application Data
(60) Provisional application No. 61/443,723, filed on Feb. 17, 2011.

(30) Foreign Application Priority Data
Jul. 26, 2010 (DE) 10 2010 032 206.7

(51) Int. Cl. H01M 4/131

(52) U.S. Cl. CPC H01M 4/131
USPC 429/220; 429/231.1; 429/221; 429/231.3; 429/223; 429/224; 429/231; 427/122

(57) ABSTRACT

The present invention relates to a particulate lithium transition metal phosphate with a homogeneous carbon coating deposited from the gas phase with as well as a process for its manufacture. The invention further relates the use of a carbon coated lithium transition metal phosphate as active material in an electrode, especially in a cathode.

The present invention relates to a lithium transition metal phosphate with a homogeneous carbon coating deposited from a gas phase. Further, the invention relates to a process for the manufacture of the carbon coated lithium transition metal phosphate. The invention relates further to the use of the carbon coated lithium transition metal phosphate as active material in an electrode of a secondary lithium ion battery as well as a battery containing such an electrode.

Doped and non-doped mixed lithium transition metal compounds have attracted considerable attention as electrode material in rechargeable secondary lithium ion batteries.

Since the pioneering work of Goodenough et al. (U.S. Pat. No. 5,910,382 and U.S. Pat. No. 6,391,493) doped and non-doped mixed lithium transition metal phosphates with an olivine structure, for example LiFePO₄ have been used as active cathode material and cathodes of secondary lithium ion batteries. These polyanionic phosphate structures, namely nasicons and olivines can raise the redox potential of low cost and environmentally compatible transition metals such as Fe, until then associated to a low voltage of insertion. For example LiFePO₄ was shown to reversibly insert-deinsert lithium ions at a voltage of 3.45 V vs. a lithium anode corresponding to a two-phase reaction. Furthermore, covalently bonded oxygen atoms in the phosphate polyanion eliminate the cathode instability observed in fully charged layered oxides, making it an inherently safe lithium-ion battery.

For the manufacture of such lithium transition metal phosphates, solid state synthesis as well as so-called hydrothermal synthesis from aqueous solution have been proposed. Further, syntheses via melt procedures or a precipitation from aqueous phases have also been described. As doping cations, for LiFePO₄, nearly all metals and transition metal cations are known in prior art.

EP 1 195 838 A2 describes the manufacture of lithium transition metal phosphates, especially LiFePO₄, by solid state synthesis wherein typically a lithium phosphate and iron(II)phosphate are mixed and sintered at temperatures of about 600° C.

Further processes for manufacture of especially lithium iron phosphate are described for example in Journal of Power Sources 119-121 (2003), 247-251, in JP 2002-151082 A as well as in DE 103 53 266.

Usually, the so obtained doped or non-doped lithium transition metal phosphate is mixed with conductive carbon black and manufactured to cathode formulations. Further, EP 1 193 784, EP 1 193 785 as well as EP 1 193 786 describes so-called carbon composite materials consisting of LiFePO₄ and amorphous carbon, the latter serves as well as additive in the manufacture of lithium iron phosphate starting from lithium carbonate, iron sulfate and sodium hydrogen phosphate and serves as reductive agent for remaining rests of Fe³⁺ in iron sulfate as well as for the inhibition of the oxidation of Fe²⁺ to Fe³⁺. The addition of carbon is assumed to increase the conductivity of the lithium iron phosphate active material in the cathode. Notably, EP 1 193 786 indicates, that carbon has to be present in an amount not less than 3 wt % in the lithium iron phosphate-carbon composite material to obtain the necessary capacity and the corresponding cycling characteristics of the material.

As pointed out by Goodenough (U.S. Pat. No. 5,910,382 and U.S. Pat. No. 6,514,640), one drawback associated with the covalently bonded polyanions in LiFePO₄ cathode materials is the low electronic conductivity and limited Li⁺ diffusivity in the material. Reducing LiFePO₄ particles to the nanoscale level was pointed out as one solution to these problems as was proposed the partial supplementation of the iron metal or phosphate polyanions by other metal or anions. One significant improvement to the problem of low electronic conductivity of alkali metal oxyanion cathode powder and more specifically of alkali metal phosphate was achieved with the use of an organic carbon precursor that is pyrolyzed onto the cathode material or its precursors, thus forming a carbon deposit, to improve the electrical conductivity at the level of the cathode particles (U.S. Pat. No. 6,855,273, U.S. Pat. No. 6,962,666, U.S. Pat. No. 7,344,659, U.S. Pat. No. 7,815,819, U.S. Pat. No. 7,285,260, U.S. Pat. No. 7,457,018, U.S. Pat. No. 7,601,318, WO 02/27823 and WO 02/27824).

Various processes have been used to make carbon-deposited lithium metal phosphate materials. As taught in U.S. Pat. No. 6,855,273 and U.S. Pat. No. 6,962,666, lithium metal phosphates can be mixed with polymeric organic carbon precursors and then the mixtures can be heated to elevated temperatures to pyrolyze the organic and to obtain carbon coating on the lithium metal phosphate particle surface.

In the specific case of carbon-deposited lithium iron phosphate, referred as C—LiFePO4, several processes could be used to obtain the material, either by pyrolyzing a carbon precursor on LiFePO₄ powder or by simultaneous reaction of lithium, iron and PO₄ sources and a carbon precursor. For example, WO 02/27823 and WO 02/27824 describe a solid-state thermal process allowing synthesis of C—LiFePO₄ through following reaction:

Fe(III)PO₄+½Li₂CO₃+carbon precursor→C—LiFe(II)PO₄

A pre-treatment by dissolving a polymeric precursor in a solvent and coating the lithium metal phosphate or its precursors with a thin layer of polymeric species in the solvent followed by drying could improve the distribution of polymeric materials and therefore improve the homogeneity of carbon deposit upon carbonization. However, the coating still remains largely inhomogeneous. Some organic materials with high molecular weight long chain polymers generate a lot of carbon residue upon thermal pyrolysis.

The distribution of these types of polymeric materials has a direct impact on the homogeneity of carbon deposit. To distribute the polymeric materials homogeneously before carbonization, especially when the polymer is melted, is essential to achieve a better coating. However, the carbon deposit is not ideally homogeneous at micro-scale when the carbon deposit is made according to the methods described above. The final carbon distribution depends on the solubility of polymeric materials in solvent, the relative affinity of polymeric materials with the solvent and with the lithium metal phosphate, the drying process, the chemical nature of the polymeric materials, the purity and catalytic effect of the lithium metal phosphate materials. In most cases, am excess of thick carbon film is observed at the junctions of the particles and on some area of the particle surface.

When the polymer loading is reduced, some particles are not well coated with carbon and severe sintering occurs. While some other particles are still coated with thick a carbon film due to inhomogeneity of the polymer distribution.

A carbon deposit can also be realized through a gas-phase reaction method as described in U.S. Pat. No. 6,855,273 and U.S. Pat. No. 6,962,666 and further in US 2004/157126. A thermal treatment of LiFePO₄ in the inert atmosphere of nitrogen mixed with 1 Vol % of propene results in carbon deposited LiFePO₄. In this process, propene decomposes to form carbon deposit on the materials being synthesized.

Chemical vapor deposition (CVD) has been widely used to coat carbon films or to grow carbon nanofiber or nanotubes on various materials. The morphology and homogeneity of carbon being grown on the material surface is highly dependent on the catalytic effect of the substrate, the catalysts added, the nature of the gaseous carbon precursor being used, the reaction temperature and reaction time. Carbon will start to deposit in localized regions and grow faster in certain regions due to a catalytic effect. At the end, a non-homogeneous carbon deposit is obtained. In some cases, carbon nanofiber/nanotubes may grow on material surfaces. Besides, for lithium metal phosphate, especially for lithium iron phosphate, severe sintering occurs when being heat treated at elevated temperatures higher than 600° C.

Prior art study has shown that a coating of organic species or carbonaceous materials on the surface of lithium metal phosphate particles can suppress sintering. While in the case of carbon deposit through gas-phase reaction using commercially available gas, no appreciable amount of carbon deposit on particle surface can be achieved before the particles have been sintered. Prior art research has also shown that too much carbon deposit on the lithium metal phosphate particle surface will cause significant decrease of the tap density of active materials and add problem to the already low material density of LiFePO₄ by decreasing further the energy density of the cathode. On top of that, electrochemical charge-discharge kinetics becomes slower due to slow transport of lithium ions through the thick carbon film. In the optimal case, the carbon surrounds each active material particle in a form as thin as possible, but still continuous. Electrons can reach the entire surface of each electroactive particle with a minimum amount of carbon required.

Problems remain to find new processes in order to make better homogeneous carbon deposit, to reduce the carbon loading, to achieve better conductivity and to suppress sintering of lithium metal phosphate particles during the carbon deposit process to obtain better and novel carbon coated materials with enhanced electrochemical properties.

Today's requirements on such materials for use especially in rechargeable lithium ion batteries of cars are very demanding, especially in relation to their discharge cycles, its capacity as well as of the purity of the electrode material. The proposed materials or material composites in the prior art do not obtain up to now the necessary electrode density since they do not provide the necessary powder press density. The press density of the material is thereby more or less correlated with the electrode density or the density of the so-called active material and in the end is also correlated with the battery capacity. The higher the press density, the higher is also the capacity of the battery.

The problem underlying the present invention was therefore to provide an improved lithium transition metal phosphate, especially for use as active material in an electrode, especially in a cathode for secondary lithium ion batteries which has with regard to the materials of prior art an increased press density, an increased capacity and a high degree of purity.

The problem is solved by a particulate lithium transition metal phosphate with a homogeneous carbon coating which is deposited from the gas phase wherein the gas phase contains pyrolysis product of a carbon containing compound.

Surprisingly it was found, that the carbon coated lithium transition metal phosphate according to the invention with a homogeneous carbon coating which was deposited from the gas phase and is present on the single shows an increase in its powder press density in the range of more than 5%, especially more than 10% compared to carbon coated lithium transition metal phosphates in the prior art, whose coating has been deposited by a different way or compared to carbon-lithium transition metal phosphate composite materials as discussed beforehand. The total carbon content of the carbon coated lithium transition metal phosphate is preferably less than 2.5 wt % based on its total weight, preferably less than 2.4 wt % or 2.0 wt %, still more preferred less than 1.5 wt % and still more preferred equal to or less than 1.1 wt %. In other preferred modes of the invention, the carbon content of the carbon coated lithium transition metal phosphate according to the invention is preferably in the range of 0.2 to 1 wt %, further 0.5 to 1 wt %, still further 0.6 to 0.95 wt %

While the increase of the press density of the lithium transition metal phosphate according to the invention, a higher electrode density is obtained by use of the carbon coated lithium transition metal phosphate as active material in an electrode. The capacity of a secondary lithium ion battery by using the electrode material according to the invention as active material in the cathode compared to the use of a material known in the prior art by at least 5%, especially by comparison to a material in the prior art which has a higher carbon content.

The term “lithium transition metal phosphate” is meant within the present invention that the lithium transition metal phosphate is present either in a doped or non-doped form. The lithium transition metal phosphate may further have an ordered or a non-ordered olivine structure.

“Non-doped” means, that pure, especially phase pure lithium transition metal phosphate is provided, i.e. by means of XRD no impurities, for example further phases of impurities (like for example lithium phosphide phases) which affect the electronic properties can be determined. Very small amounts of starting materials, like Li₃PO₄ or Li₄P₂O₇ detectable by XRD are in the context of the present invention not regarded as impurities affecting the electronic properties of the material according to the invention.

As doping metals, all metals known to a person skilled in the art are suitable for the use according to the present invention. In a preferred embodiment, the lithium transition metal phosphate is doped with Mg, Zn and/or Nb. The ions of the doping metal are present in all doped lithium transition metal phosphate in an amount of 0.05 to 10 wt %, preferably 1-3 wt % compared to the total weight of the lithium transition metal phosphate. The doping metal cations are either on the lattice sites of the metal or of the lithium.

Exceptions from the above-described doping are mixed Fe, Co, Mn, Ni lithium phosphates which comprise at least two of the above-mentioned elements wherein also higher amounts of doping metal cations may be present, in some cases up to 50 at %.

In one embodiment of the present invention, the carbon coated lithium transition metal phosphate is represented by formula (1)

LiM′_{y}M″ₓPO₄ (1)

wherein M″ is at least one transition metal selected from the group Fe, Co, Ni and Mn, M′ is different from M″ and represents at least one metal, selected from the group consisting of Co, Ni, Mn, Fe, Nb, Ti, Ru, Zr, B, Mg, Zn, Ca, Cu, Cr or combinations thereof, with 0<x≦1 and wherein 0≦y<1.

Compounds according to the invention are for example carbon coated LiNb_{y}FeₓPO₄, LiMg_{y}FeₓPO₄ LiB_{y}FeₓPO₄ LiMn_{y}FeₓPO₄, LiCo_{y}FeₓPO₄, LiMn_{z}Co_{y}FeₓPO₄ with 0<x≦1 and 0≦y, z<1.

Further compounds according to the invention are carbon coated LiFePO₄, LiCoPO₄, LiMnPO₄ and LiNiPO₄. Especially preferred is carbon coated LiFePO₄ and its doped derivatives.

In a further embodiment of the present invention, the carbon coated lithium transition metal phosphate is represented by formula (2)

LiFeₓMn_{1-x-y}M_{y}PO₄ (2)

wherein M is a metal with a valency +II of the group Sn, Pb, Zn, Mg, Ca, Sr, Ba, Co, Ti and Cd and wherein x<1, y<0.3 and x+y<1.

In further embodiments of the present invention the carbon coated compounds according to formula (2) M is Zn, Mg, Ca or combinations thereof, especially Zn and Mg. Surprisingly it was found within the scope of the present invention, that these electrically inactive substitution or doping elements enable the provision of carbon coated materials with an especially high energy density if used as active material in electrodes.

It was found that in the substituted lithium metal phosphate of formula (2) LiFeₓMn_{1-x-y}M_{y}PO₄ the value for y is preferably 0.1.

The substitution (or doping) by per se electrochemically inactive metal cations with a valency +II appears to give with the especially preferred values of x=0.1 and y=0.1 the best results with regard to the energy density when used as active material in electrodes.

In further embodiments of the present invention, the value for x in the mixed carbon coated lithium transition metal phosphate of formula (2) LiFeₓMn_{1-x-y}M_{y}PO₄ is 0.33. This value, especially in connection with the above-mentioned especially preferred value for y is the most preferred compromise between energy density and current resistance of the electrode material according to the invention. The means that the compound LiFeₓMn_{1-x-y}M_{y}PO₄ with x=0.33 and y=0.10 has a better current resistance up to 20% during discharge as for example LiFePO₄ in the prior art (commercially obtainable from Süd-Chemie AG), but in addition for example with x=0.1 and y=0.1 also an increase in energy density (10% with regard to LiFePO₄) measured against an anode comprising lithium titanate (Li₄Ti₅O₁₂) as active material.

In a further embodiment of the present invention the carbon coated lithium transition metal phosphate is a carbon coated mixed Li(Fe,Mn)PO₄, for example carbon coated LiFe_{0.5}Mn_{0.5}PO₄.

The particle size distribution of the particles of the carbon coated lithium transition metal phosphate according to the invention is preferably bimodal, wherein the D₁₀ value of the particles is preferably ≦0.25, the D₅₀ value preferably ≦0.85 and the D₉₀ value ≦4.0 μm.

A small particle size of the carbon coated lithium transition metal phosphate according to the invention provides when used as active material in an electrode in a secondary lithium ion battery provides a higher current density and also a lower resistance of the electrode.

The BET surface (according DIN ISO 9277) of the particles of the carbon coated lithium transition metal phosphate according to the invention is ≦15 m²/g, especially preferred ≦14 m²/g and most preferred ≦13 m²/g. In still further embodiments of the present invention, values of ≦11 m²/g and ≦9 m²/g may be obtained. Small BET surfaces of the active material have the advantage, that the press density and thereby the electrode density, hence the capacity of the battery are increased.

In the sense of the present invention, the term “carbon coating deposited from the gas phase” means that the carbon coating is generated by pyrolysis of a suitable precursor compound wherein a carbon containing gas phase (atmosphere) with the pyrolysis product(s) of a suitable precursor compound is formed from which a carbon containing coating is deposited on the particles of the lithium transition metal phosphate. After deposition, the initially carbon containing deposit or coating is then fully carbonized (pyrolyzed). The carbon of the coating consists thereby of so-called pyrolysis carbon. The term “pyrolysis carbon” designates an amorphous material of non crystalline carbon in contrast to for example graphite, carbon black etc.

The pyrolysis carbon is obtained by heating, i.e. pyrolysis at temperatures of about 300 to 850° C. of a corresponding carbon containing precursor compound in a reaction vessel, for example a crucible. Especially preferred is a temperature of 500 to 850° C., still more preferred 700 to 850° C. In further embodiments, the pyrolysis temperature is 750 to 850° C. The lithium transition metal phosphate is during pyrolysis not in the same reaction vessel as the carbon containing precursor but is spatially separated from the carbon containing precursor compound and is in another reaction vessel.

Typical precursor compounds for pyrolysis carbon are for example carbohydrates like lactose, sucrose, glucose, starch, cellulose, polymers like for example polystyrene butadiene block copolymers, polyethylene, polypropylene, maleic- and phthalic acid anhydride based polymers, aromatic compounds like benzene, anthracene, toluene, perylene as well as all further suitable compounds and/or combinations thereof known per se to a person skilled in the art.

In the present invention, the precursor compound is preferably selected from a carbohydrate, i.e. a sugar, especially preferred is lactose or lactose compounds since they have reducing properties (i.e. upon cracking or decomposition they protect the starting materials and/or the final product from oxidation) or cellulose. Most preferred is α-lactose monohydrate.

In another preferred embodiment, the carbon precursor compound is a polymer which generates low molecular weight gaseous species, like polyethylene, polypropylene, polyisoprene, maleic or phthalic acid anhydride based polymers, like for example poly(maleic-anhydride-1-octadecene).

During pyrolysis, the carbon containing precursor compound decomposes to a variety of low molecular weight gaseous pyrolysis products. In the case of α-lactose monohydrate, the pyrolysis products are CO₂, CO and H₂ in an amount of each of about 20 to 35 vol. %, accompanied by about 10 vol. % CH₄ and about 3 vol. % ethylene. CO, H₂ as well as further reducing gaseous compounds protect the lithium transition metal phosphate, for example LiFePO₄ from oxidation and inhibit further that undesired higher oxidation states of a transition metal, for example Fe³⁺ ions are formed since these species are reduced immediately during reaction by the reducing gaseous compounds.

The deposit of the carbon coating from the gas phase yields a material which has compared to materials of prior art a considerably increased powder press density (vide infra).

In one embodiment of the present invention, the carbon coated lithium transition metal phosphate according to the invention has a powder press density of 1.5, further preferred 2, still more preferred 2.1, still more preferred 2.4 and especially 2.4 to 2.8 g/cm³.

In a further embodiment of the present invention, the pyrolysis of the carbon precursor compounds is carried out preferably in a temperature range of 750 to 850° C., wherein subsequently, powder press densities of the lithium transition metal phosphate according to the invention are obtained in the range of >1.5 g/cm³ to 2.8 g/cm³, preferably 2.1 to 2.6 g/cm³, still more preferred 2.4 to 2.55 g/cm³. In an especially advantageous embodiment of the invention, the pyrolysis and final carbonization is carried out at about 750° C., wherein a powder press density of the lithium transition metal phosphate according to the invention of more than 2.5 g/cm³, preferably 2.5 to 2.6 g/cm³ is obtained.

The deposition of pyrolysis carbon from the gas phase, especially in the case where the gas phase is generated by pyrolysis of a carbohydrate as for example lactose, a lactose compound or cellulose, yields a carbon coated product with a very low sulfur content. The (total) sulfur content of the carbon coated lithium transition metal phosphate according to the invention is preferably in a range of 0.01 to 0.15 wt %, more preferred 0.03 to 0.07 wt %, most preferred 0.03 to 0.04 wt %. The determination of the sulfur content is carried out preferably by combustion analysis in a C/S determinator ELTRA CS2000.

The carbon coated lithium transition metal phosphate according to the invention has further the advantage that it has a powder density of ≦10 Ω·cm, preferably ≦9 Ω·cm, more preferred ≦8 Ω·cm, still more preferred ≦7 Ω·cm and most preferred ≦5 Ω·cm. The lower limit of the powder density is preferably ≧0.1, still more preferred ≧1, still more preferred ≧2 and most preferred ≧3 Ω·cm.

Surprisingly it was found that the powder density of the carbon coated lithium transition metal phosphate according to the invention depends on the temperature during pyrolysis (and subsequent carbonization) of the carbon containing precursor compound.

As already discussed in the foregoing, according to an embodiment of the present invention, the coating on the particles of a lithium transition metal phosphate by pyrolysis carbon is obtained by pyrolysis of a suitable precursor compound at 700 to 850° C., wherein the such obtained lithium transition metal phosphate according to the invention has a powder resistivity of about 2 to 10 Ω·cm. According to a further embodiment of the invention, the coating of pyrolysis carbon is obtained by pyrolysis of a suitable precursor compound in the range of 700 to 800° C., wherein the lithium transition metal phosphate according to the invention has a powder resistivity of about 2 to 4 Ω·cm. After pyrolysis of the precursor compound at 750° C., the powder resistivity is 2±0.1 Ω·cm.

In a further embodiment of the invention, the particles of the lithium iron transition metal phosphate, notably the lithium iron phosphate have a spherical form. The term “spherical” is understood in the sense of the present invention as being a ball-shaped body which may deviate in variations from an ideal ball form. Especially preferred are particles wherein the ratio length/width of the particles is 0.7 to 1.3, preferably 0.8 to 1.2, more preferably 0.9 to 1.1 and especially preferably circa 1.0. The spherical morphology of the particles is formed preferably during the coating (and final carbonization) with the pyrolysis carbon. This is especially the case when the lithium transition metal phosphate to be coated is synthesized by a so-called hydrothermal synthesis. However, the way of the synthesis of the lithium transition metal phosphate to be coated is not relevant for carrying out the present invention.

According to a further embodiment of the invention, the lithium transition metal phosphate according to the invention has a specific capacity of ≧150 mAh/g, more preferred ≧155 mAh/g, still more preferred ≧160 mAh/g (measuring conditions: C/12 rate, 25° C., 2.9 V to 4.0 V against Li/Li⁺).

Due to the above described preferable physical properties of the lithium transition metal phosphate according to the invention, it is exceptionally suitable as being used as active material in an electrode, especial in a cathode in a secondary lithium ion battery.

A further aspect of the present invention is therefore the use of the lithium transition metal phosphate according to the invention as active material in a cathode of the secondary lithium ion battery.

A further aspect of the present invention is a process for the manufacture of the carbon coated lithium transition metal phosphate according to the invention. By this process, a thin layer (coating) of carbonaceous materials on lithium transition metal phosphate particles is coated homogeneously on the particles and then the carbonaceous material is carbonized at the same or more elevated temperatures in a controlled manner to avoid localized deposition of carbon through gas phase. The process comprises the steps of:
a) the provision of a particulate lithium transition metal phosphate or its precursor compounds,
b) the deposition of a carbonaceous coating on the lithium transition metal phosphate particles by exposing the particles to an atmosphere, or the particles of a precursor compounds of lithium transition metal phosphate to an atmosphere, comprising pyrolysis products of a carbon containing compound,
c) the carbonization of the carbonaceous coating.

In a first step, polymeric material is cracked at lower temperature to generate gaseous low molecular weight organic species and then a thin layer of carbonaceous materials is homogeneously coated on lithium transition metal phosphate by passing the gas stream through the lithium metal phosphate powder bed.

The thickness of the organic coating can be controlled by the exposure time of the lithium transition metal phosphate materials, or its precursors, to the gaseous low molecular weight organic materials or by adjusting the concentration of the organic atmosphere. To control the concentration of the low molecular weight organic species in the gas stream, the cracked organic species can be mixed with an inert carrier gas like nitrogen or argon, or with reducing gas like CO, H₂ or any other commercially available organic gas like methane, propane, propylene.

All polymers that decompose and generate low molecular weight gaseous organic species at temperature below 500° C. can be used. Preferably, organic polymeric materials are decomposed at temperature below 400° C. Examples of polymeric materials include but are not limited to polyalcohols like polyglycols, as for example Unithox 550, poly(maleic-anhydride-1-octadecene), lactose, cellulose, polyethylene, polypropylene and so on.

In a preferred mode, the first step of organic coating of lithium metal phosphate materials in gas phase is performed in the temperature range of 300-400° C. In this temperature range, no sintering of lithium transition metal phosphate will occur. Therefore, organic coating at this temperature range can assure that all particle surfaces be coated with a thin layer of organic carbonaceous species in the organic atmosphere. In order to make sure all particles are exposed to organic atmosphere, the powder can be stirred, rotated in a rotary kiln or floated by the gaseous organic species in a fluid bed furnace.

In other embodiments of the invention, the step b) (cracking and deposition of a carbonaceous layer) and step c) (final carbonization of the carbonaceous layer) may be carried out at the same temperature between 300 to 850° C. in one single step.

It goes without saying that the lithium transition metal phosphate being coated and the polymeric materials can be at different temperatures in two different furnaces or in the same furnace but at different sections. The gaseous stream generated by evaporating the polymeric materials is put in contact with the powders of the lithium transition metal phosphate or its precursors at various temperatures. The temperature of the polymeric materials is set according to the nature and decomposition temperature of the polymeric materials. While the temperature of the lithium metal phosphate that is exposed to the organic gaseous materials can be set at any temperatures below the sintering temperature of lithium metal phosphate particles.

In a preferred mode, the particles of the lithium transition metal phosphate or its precursors are set at lower temperatures than that of the gas stream to help the condensation of gaseous organic species on the particle surface. In another preferred mode of embodiment, the lithium metal phosphate, or its precursors, particles are intensively milled while exposing to the organic gas stream in order to de-agglomerate the lithium metal phosphate particles or its precursors and to coat organic materials on every corner of the primary particles.

In a second step, the lithium transition metal phosphate, or its precursors, coated with organic carbonaceous species is heat treated at preferably higher temperature (or the same as during pyrolysis) to obtain a homogeneous carbon coating with low carbon loading. The total carbon loading or the thickness of the carbon coating is mainly controlled by the organic coating in the first step.

The conductivity of the carbon coating is highly influenced by the carbonization temperature, the higher is the carbonization temperature, the better is the conductivity. A homogeneous organic coating of the particles will allow higher carbonization temperatures without sintering compared with the state of the art method for carbon coating.

In embodiments of the invention, carbonization time is longer than 0.1 min at 300-850° C., preferably 400 to 850° C. In order to achieve high conductivity, the carbonization time should be in one embodiment of the invention longer than 0.1 min at 700° C. On the other hand, it is noticed that if the sintering time is too long, carbon deposition through gas-phase reaction leads to formation of carbon clusters on the carbon coating layers.

Lithium transition metal phosphate can be synthesized by any method in the art, such as hydrothermal, by precipitation from aqueous solutions, sol-gel/pyrolysis, solid state reaction or melt casting. The lithium metal phosphate particles can be further reduced to fine particles by milling before carbon coating.

The post coating carbonization process is preferably performed in the temperature range of 300° C.-850° C., preferably 400 to 750° C. The carbonization time is between 0.1 min to 10 hours to achieve high conductivity but to avoid sintering and further severe carbon growth on the surface at elevated temperatures in the gas phase. In a preferred mode of application, the thickness of the organic coating is controlled in the range of 0.5 to 10 nm, preferably 1 to 7 nm, in other embodiments 1 to 3 nm.

The lithium transition metal phosphate used in the process of the present invention is a compound of formula (1)

LiM′_{y}M″ₓPO₄ (1)

wherein M″ is at least one transition metal selected from the group Fe, Co, Ni and Mn, M′ is different from M″ and represents at least a metal, selected from the group consisting of Co, Ni, Mn, Fe, Nb, Ti, Ru, Zr, B, Mg, Zn, Ca, Cu, Cr or combinations thereof, 0<x≦1 and wherein 0≦y<1.

Preferred compounds are typically for example LiNb_{y}FeₓPO₄, LiMg_{y}FeₓPO₄ LiB_{y}FeₓPO₄ LiMn_{y}FeₓPO_{4,} LiCo_{y}FeₓPO₄, LiMn_{z}Co_{y}FeₓPO₄ with 0<x≦1 and 0≦y, z<1.

In a further embodiment of the present invention, the lithium transition metal phosphate used in the process is represented by formula (2)

LiFeₓMn_{1-x-y}M_{y}PO₄ (2)

wherein M is a metal with valency +II of the group Sn, Pb, Zn, Mg, Ca, Sr, Ba, Co, Ti and Cd and wherein x<1, y<0.3 and x+y<1.

As already discussed in the foregoing, the lithium transition metal phosphates used in step a) of the process of the invention are synthesized by processes per se known to a person skilled in the art, like for example solid state synthesis, hydrothermal synthesis, precipitation from aqueous solutions, flame spraying pyrolysis etc.

In further embodiments of the present invention, it is also possible to synthesize the lithium transition metal phosphate in situ in step b) of the present process. In this case, only precursor compounds for lithium transition metal phosphate, i.e. a transition metal precursor, either in its final +II valence state or in a reducible higher valence state, a lithium compound like LiOH, lithium carbonate etc and a phosphate compound like a hydrogen phosphate are mixed and the reaction to the final lithium transition metal takes place before (since carbon is consumed when reduction of a precursor transition metal compound with a higher valency than +II is necessary) during initial coating of the particles

In still further embodiments of the process according to the invention, besides the electrode material according to the invention a further lithium metal oxygen compound is provided in step a). This additive increases the energy density up to circa 10 to 15%, depending on the nature of the further mixed lithium metal oxygen compound compared to active materials which only contain the lithium transition metal phosphate according to the invention as a single active material.

The further lithium metal oxygen compound is preferably selected from substituted or non-substituted LiCoO₂, LiMn₂O₄, Li(Ni,Mn,Co)O₂, Li(Ni,Co,Al)O₂ and LiNiO₂ as well as LiFe_{0.5}Mn_{0.5}PO₄ and Li(Fe,Mn)PO₄ and mixtures thereof.

As already discussed above, it is preferred that the carbon containing precursor compound is a carbohydrate compound or a polymer. Typical suitable precursor compounds are of carbohydrates for example lactose, sucrose, glucose, starch, cellulose. Among the polymers, for example polystyrene butadiene block copolymers, polyethylene, polypropylene, polyalcohols like polyglycols, polymers based on maleic- and phthalic acid anhydride, aromatic compounds as benzene, anthracene, toluene, perylene as well as all further suitable compounds known per se to a person skilled in the art can be used as well as combinations thereof.

Within the scope of the present invention it is especially preferred when the precursor compound is selected from a carbohydrate, notably a sugar, especially preferred from lactose or a lactose compound or cellulose. Most preferred is α-lactose monohydrate. Also preferred are as already discussed above, polyalcohols like polyglycols as for example Unithox 550, or polymers based on maleic- and phthalic acid anhydride as for example poly(maleic-anhydride-1-octadecene).

During pyrolysis, the carbon containing precursor compound is decomposed. The pyrolysis products are in the case of α-lactose monohydrate CO₂, CO and H₂ in an amount of circa 20 to 35 vol. % each, together with 10 vol. % CH₄ and circa 3 vol. % ethylene. The CO₂, H₂ as well as the further producing gaseous compounds are protecting the lithium transition metal phosphate or the generated lithium transition metal phosphate during the process according to the invention against oxidation. Further, these compounds are useful to reduce unwanted higher valency states of the transition metal, like for example Fe³⁺ in the case of LiFePO₄ which may be present in the corresponding structures or in the corresponding starting materials. The process according to the invention provides carbon-coated particulate lithium transition metal phosphates which are free from phosphide phases, for example in the case of LiFePO₄ free from crystalline Fe₂P. The presence or non-presence of phosphide phases may be determined by XRD measurements.

The pyrolysis is carried out preferably in a reaction chamber where as already outlined above the particles to be coated of the lithium transition metal phosphate or its precursor compounds and the carbon containing precursor compound to be pyrolyzed are not in direct contact with each other. It is preferred that the particles to be coated have usually a lower temperature than the gaseous phase to increase the deposit rate. Preferably, the lithium transition metal phosphate is exposed during deposition to a temperature of 300 to 850° C. This temperature is in some embodiments of the invention the same as the temperatures for pyrolysis.

In a further embodiment of the invention, the coating is carried out in a fluid bed, i.e. the particles of lithium transition metal phosphate and/or its precursor compounds are singled out in a fluid bed and the gas phase containing the pyrolysis products is passed through the fluid bed. Thereby, an extremely homogeneous coating of the particles is obtained and the formation of a spherical form of the coated particles is compared to a coating from the gas phase without the use of a fluid bed still increased.

The deposition of the carbon coating from the gas phase of the process according to the invention provides lithium transition metal phosphate particles homogeneously coated with carbon. These particles have a very small overall amount of carbon and a very high powder press density which may be controlled according to the temperature of the pyrolysis of the carbon precursor compounds and provides therefore for a material which a very low resistivity.

The term “homogeneous” in the term of the present invention means that there are no agglomerates of carbon particles on the lithium transition metal phosphate particles as for example in the case of the so-called “bridged carbon” coating according WO 02/923724 but each single carbon coated lithium transition metal phosphate particle is separated from the other particle and has a homogeneous and continuous coating of carbon. This means that for example clusters of carbon as obtained by other methods or an uneven distribution of the carbon in the coating layer are not present on the surface of the carbon coated particles obtained according to the process of the present invention.

In one embodiment of the invention, the carbon content of the carbon coated lithium transition metal phosphate according to the invention is in the range of 0.7 to 0.9 wt % when pyrolysis is carried out at 300 to 500° C.

In a further embodiment of the invention, the carbon coated lithium transition metal phosphate according to the invention has a carbon content of 0.6 to 0.8 wt % when pyrolysis (and carbonizing) is carried out at 800 to 850° C.

In still a further embodiment of the present invention, the lithium transition metal phosphate according to the invention has a carbon content of 0.9 to 0.95 wt % when pyrolysis (and carbonizing) is carried out at temperatures from 600 to 700° C.

The powder press density of the material obtained by the process according to the invention is ≧1.5, more preferred ≧2, still more preferred ≧2.1, still more preferred ≧2.4 and especially preferred 2.4 to 2.8 g/cm³.

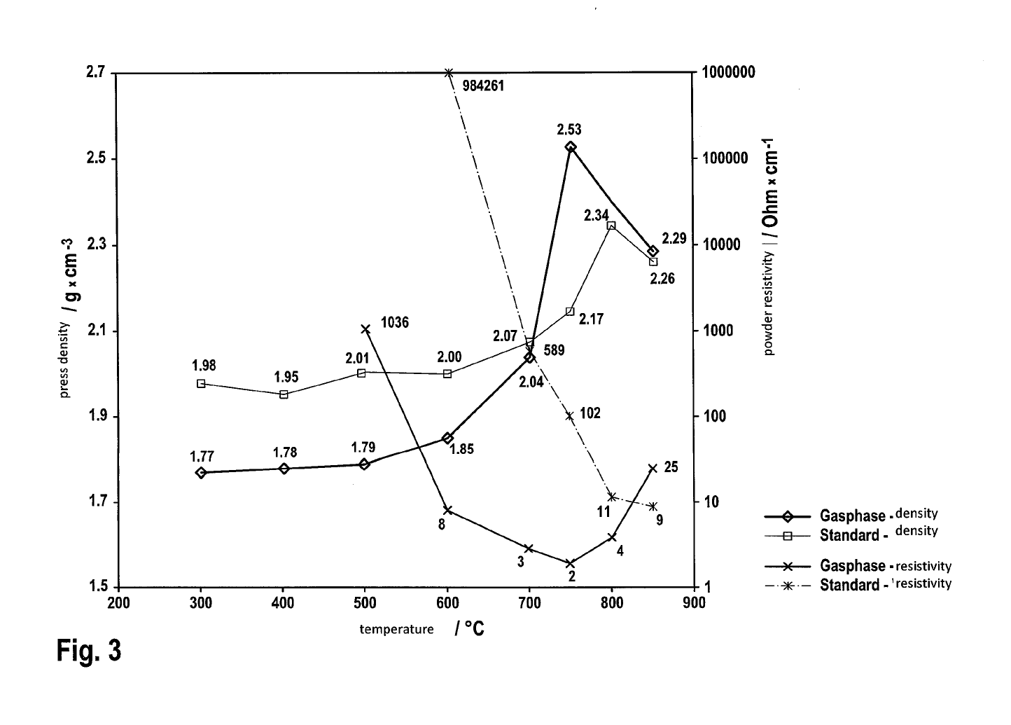

As is the case with the total carbon content, the powder press density is variable depending on the pyrolysis temperature. If the pyrolysis (and carbonization) is carried out in the range of 750 to 850° C., powder press densities in the range of >1.5 g/cm³ to 2.8 g/cm³, preferably to 2.1 to 2.6 g/cm³, still more preferred 2.4 to 2.55 g/cm³ are obtained. If pyrolysis (and carbonization) is carried out at about 750° C., a powder press density of more than 2.5 g/cm³, preferably 2.5 to 2.6 g/cm³ is obtained (see also FIG. 3).

The powder resistivity of the material obtained by the process according to the invention and coated with the carbon is about ≦10 Ω·cm, preferably ≦9 Ω·cm, more preferably ≦8 Ω·cm, still more preferred ≦7 Ω·cm and most preferred ≦5 Ω·cm. The lower limit of the powder resistivity is ≧0.1, preferably ≧1, more preferred ≧2, still more preferred ≧3 Ω·cm.

The material which is manufactured according to the invention has a powder resistivity from about 2 to 10 Ω·cm if pyrolysis (and subsequent carbonization) of the precursor compound is carried out at a temperature of about 700 to 850° C.

If pyrolysis (and carbonization) of the precursor compound is carried out at 700 to 800° C., the material according to the invention has a powder resistivity of about 2 to 4 Ω·cm. If pyrolysis of a precursor compound is carried out 750° C., the powder resistivity of the material such obtained is about 2±1 Ω·cm.

The process according to the invention also yields a product with very low sulfur content. The sulfur content of the product is preferably in the range of 0.01 to 0.15 wt %, more preferred 0.03 to 0.07, most preferably 0.03 to 0.04 wt % of the total weight.

The process according to the invention yields preferably particles of lithium transition metal phosphates which have a spherical form. The term “spherical” is understood as defined beforehand. As already discussed, the particle which have been obtained according to the invention have a length/width ratio from 0.7 to 1.3, preferably 0.8 to 1.2, more preferably 0.9 to 1.1 and especially preferred around 1.0. The spherical morphology of the coated particle is formed preferably during the coating, independent of the morphology of the particles of the lithium transition metal phosphate used. Without being bound to a specific theory, it is assumed that by the spherical form of a lithium transition metal phosphate particle coated with carbon, a higher packing density can be obtained compared to simple ball-shaped particles. Therefore, a higher powder press density is obtained, whose influence on electrode density and battery capacity is already described beforehand.

According to the invention as already discussed beforehand it is not essential how the synthesis of the lithium transition metal phosphate before its use in the process according to the invention is carried out. I.e., the lithium transition metal phosphate can either be obtained by a so-called solid state synthesis, by a hydrothermal synthesis, by precipitation from aqueous solution or by further processes essentially known to a person skilled in the art.

Further, it is also possible, that the synthesis of the lithium transition metal phosphate takes place in one step during (or before) coating of the particles of suitable precursor compounds as already described beforehand.

However, it was found that the use of hydrothermally synthesized lithium transition metal phosphate is especially preferred within the process according to the invention. Lithium transition metal phosphates obtained by hydrothermal processes have usually less impurities than lithium transition metal phosphates obtained by solid state synthesis.

The carbon coated lithium transition metal phosphate which was manufactured according to the invention has a specific capacity of ≧150 mAh/g, more preferably ≧155 mAh/g, still more preferred ≧160 mAh/g.

A further aspect of the present invention is therefore also an electrode comprising the lithium transition metal phosphate according to the invention or mixtures thereof as active material.

The electrode is preferably a cathode. Since the active material according to the invention has a higher press density than material in the prior art, markedly increased higher electrode active mass densities are the result compared to the use of materials of the prior art. Thereby, also the capacity of a battery is increased by using such an electrode. A typical electrode formulation contains besides the aforementioned active material still a binder.

As binder, each binder essentially known to a person skilled in the art can be used, as for example polytetrafluoroethylene (PTFE), polyvinylidenedifluoride (PVDF), polyvinylidenedifluoride hexafluoropropylene copolymers (PVDF-HFP), ethylene-propylene-diene terpolymers (EPDM), tetrafluoroethylene-hexafluoropropylene copolymers, polyethylene oxides (PEO), polyacrylonitrile (PAN), polymethylmethacrylate (PMMA), carboxymethyl celluloses (CMC), the derivatives and mixtures thereof. The amount of binder in the electrode formulation is about 2.5 to 10 weight parts.

In further embodiments of the invention, an electrode with a carbon coated lithium transition metal phosphate according to the invention as an active material contains preferably a further lithium metal oxygen compound (lithium metal oxide).

This additive increases the energy density by about 10 to 15% depending on the nature of the further mixed lithium metal oxygen compound compared to materials which contain only a lithium transition metal phosphate according to the invention as a single active material.

The further lithium metal oxygen compound is preferably selected from substituted or non-substituted LiCoO₂, LiMn₂O₄, Li(Ni,Mn,Co)O₂, Li(Ni,Co,Al)O₂ and LiNiO₂, as well as LiFe_{0.5}Mn_{0.5}PO₄ and Li(Fe,Mn)PO₄ and mixtures thereof.

In some embodiments of the invention, it is possible to avoid the use of further (conductive) additives with the active material in the electrode formulation, i.e. in the electrode formulation only active material and binder are comprised. In further embodiments of the invention it is also possible, that a conductive additive as for example carbon black, Ketjen black, acetylene black, graphite etc. may be present in the formulation in about 2.5-20 weight parts, preferably less than 10 weight parts. Especially preferred is for example an electrode formulation of 95 weight parts active material, 2.5 weight parts binder and 2.5 weight parts additional conductive additive.

The electrode according to the invention has typically an electrode density of >1.5 g/cm³, preferably >1.9 g/cm³, especially preferred about 2 to 2.2 g/cm³.

Typical specific discharge capacities at C/10 for an electrode according to the invention are in the range of 140 to 160 mAh/g, preferably 150 to 160 mAh/g.

For the manufacture of an electrode, usually slurries are prepared in a suitable solvent, for example in NMP (N-methylpyrrolidone). The resulting suspension is then coated on a suitable support for example an aluminum foil. Then, the coated electrode material is preferably pressed with a hydraulic press about 1 to 8 times, more preferred 3 to 5 times at 5 to 10 t pressure, preferably 7 to 8 t. According to the invention, the pressing can also be carried out with a calender press or a roll, preferably by a calender press.

A further aspect of the present invention is a secondary lithium ion battery containing an electrode according to the invention as cathode, wherein a battery with a higher electrode density is obtained which has a higher capacity as secondary lithium ion batteries in the prior art. Thereby, the use of such lithium ion batteries according to the invention especially in automobiles is possible since the batteries can have small dimensions.

The invention is further explained in detail by way of figures and examples which are being understood as not limiting the scope of the invention.

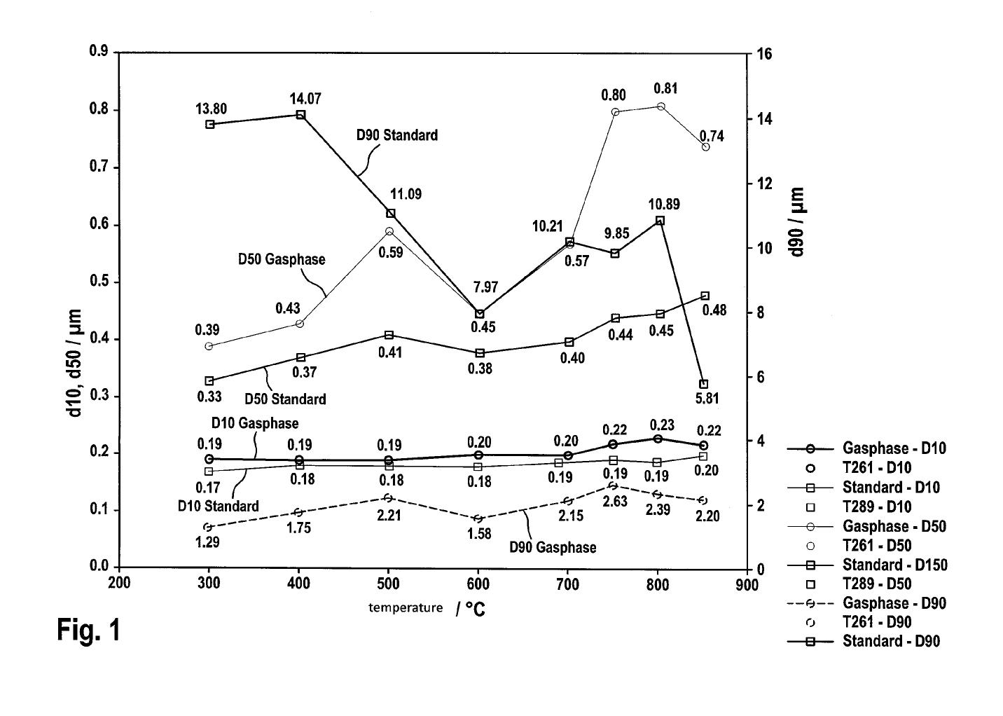

FIG. 1 shows the particle size distribution (D₁₀, D₅₀, D₉₀) of LiFePO₄ obtained according to the invention in comparison to a LiFePO₄ which was coated with carbon according to example 3 of EP 1 049 182 (in the following: “prior art”),

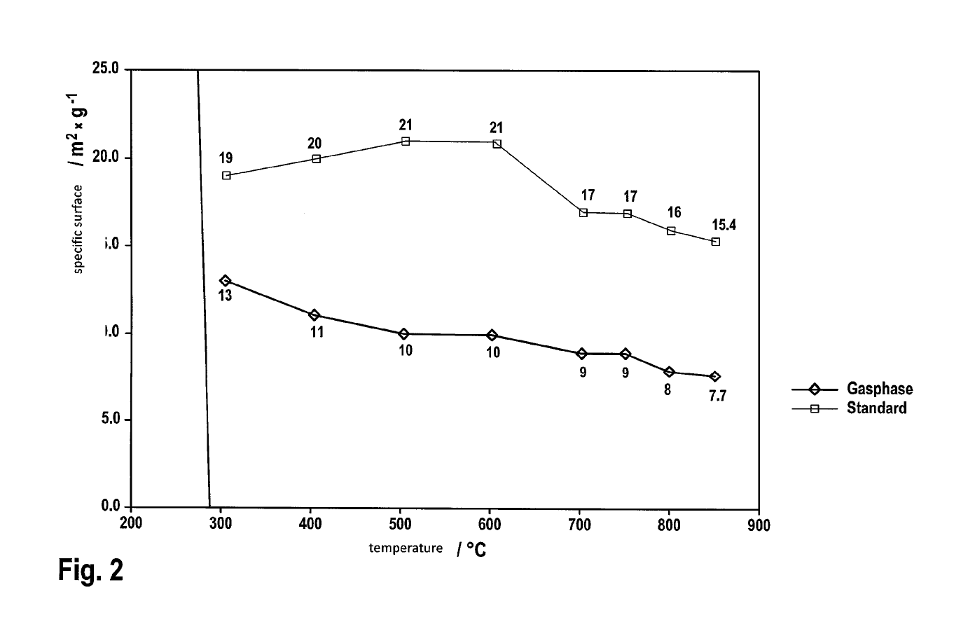

FIG. 2 the BET surface of carbon coated LiFePO₄ according to the invention compared to carbon coated LiFePO₄ of prior art,

FIG. 3 a correlation between the powder press density and the powder resistivity of carbon coated LiFePO₄ according to the invention in comparison to carbon coated LiFePO₄ of prior art,

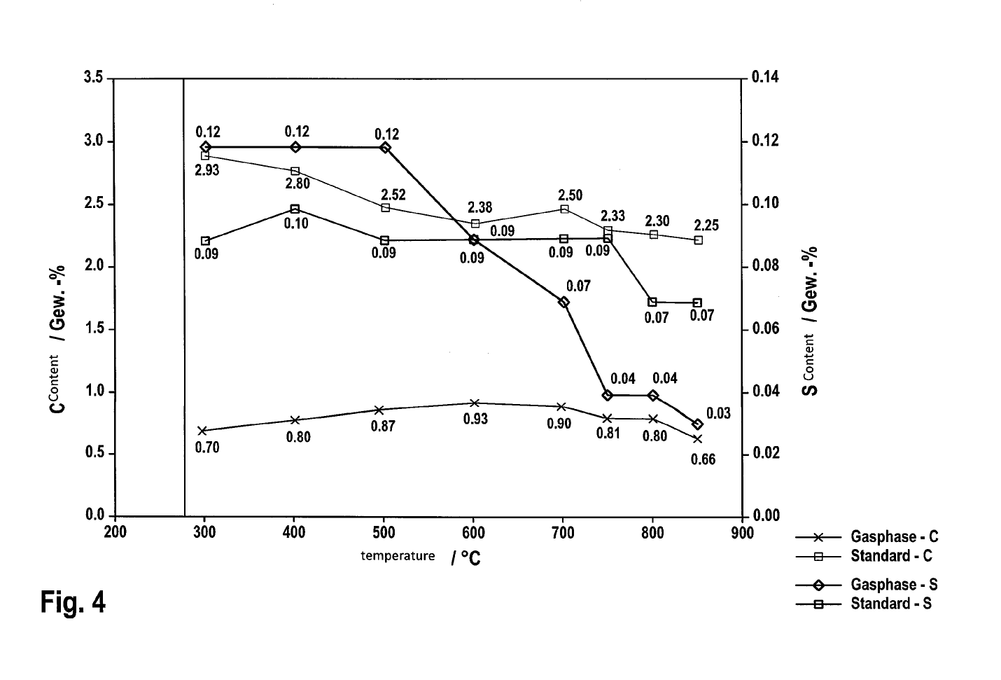

FIG. 4 the carbon content and the sulfur content of carbon coated LiFePO₄ according to the invention in comparison to carbon coated LiFePO₄ of prior art.

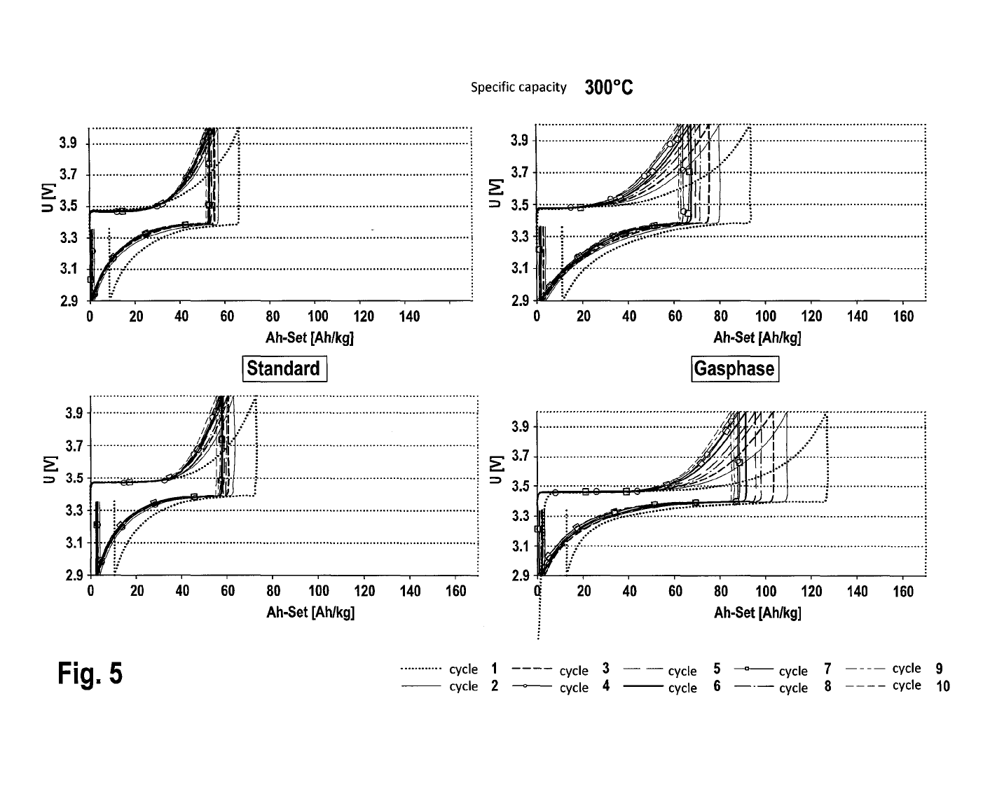

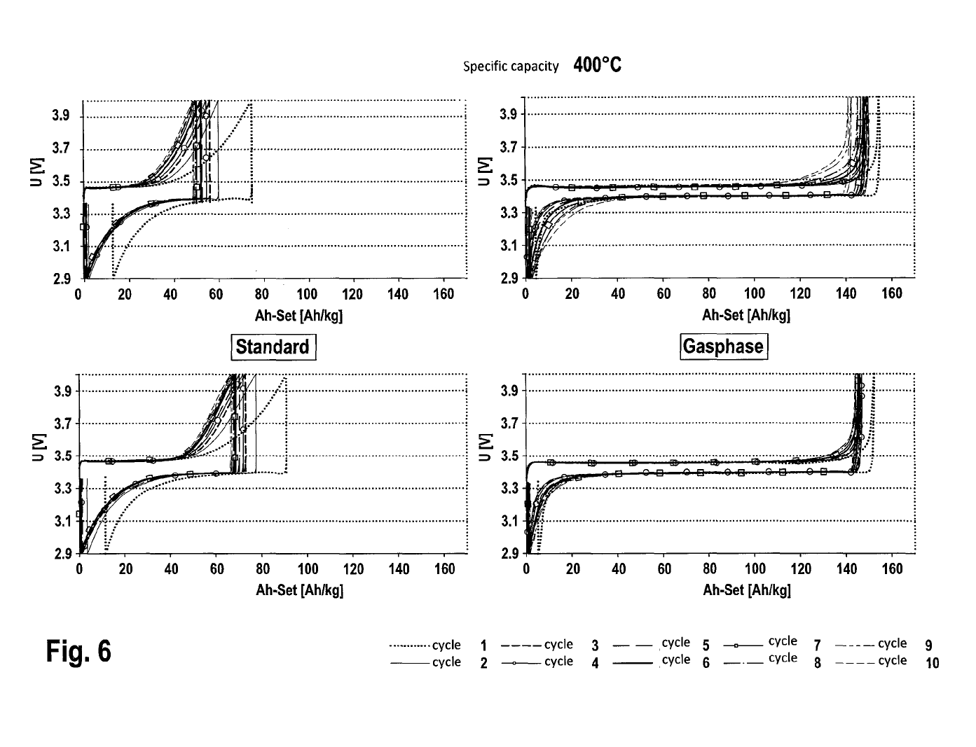

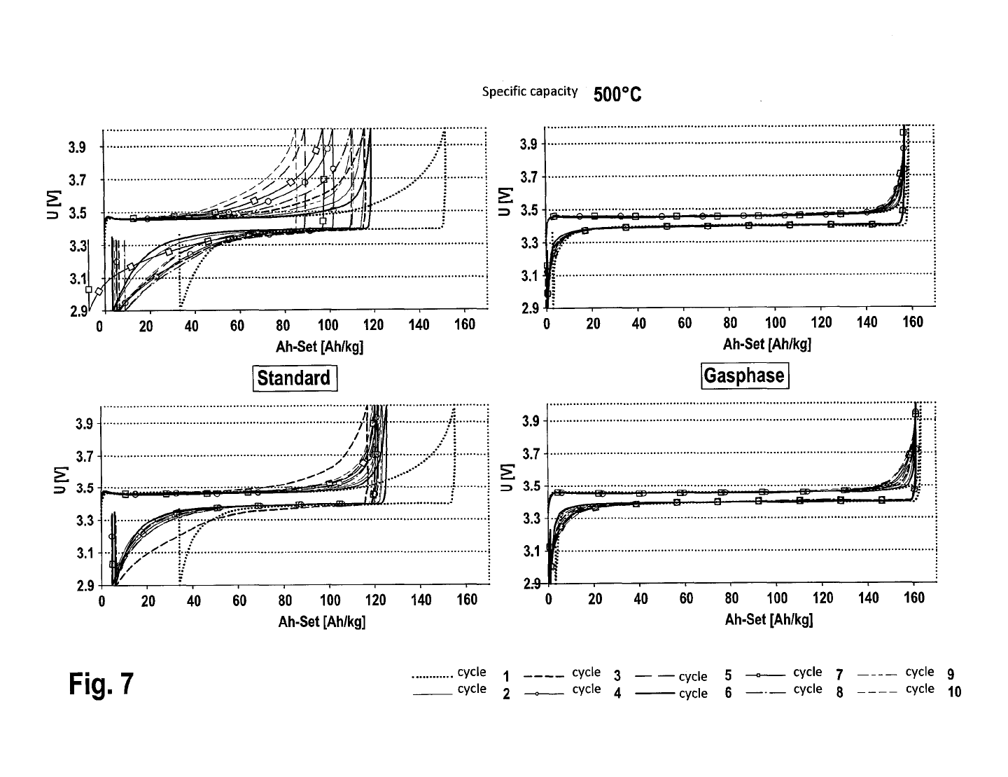

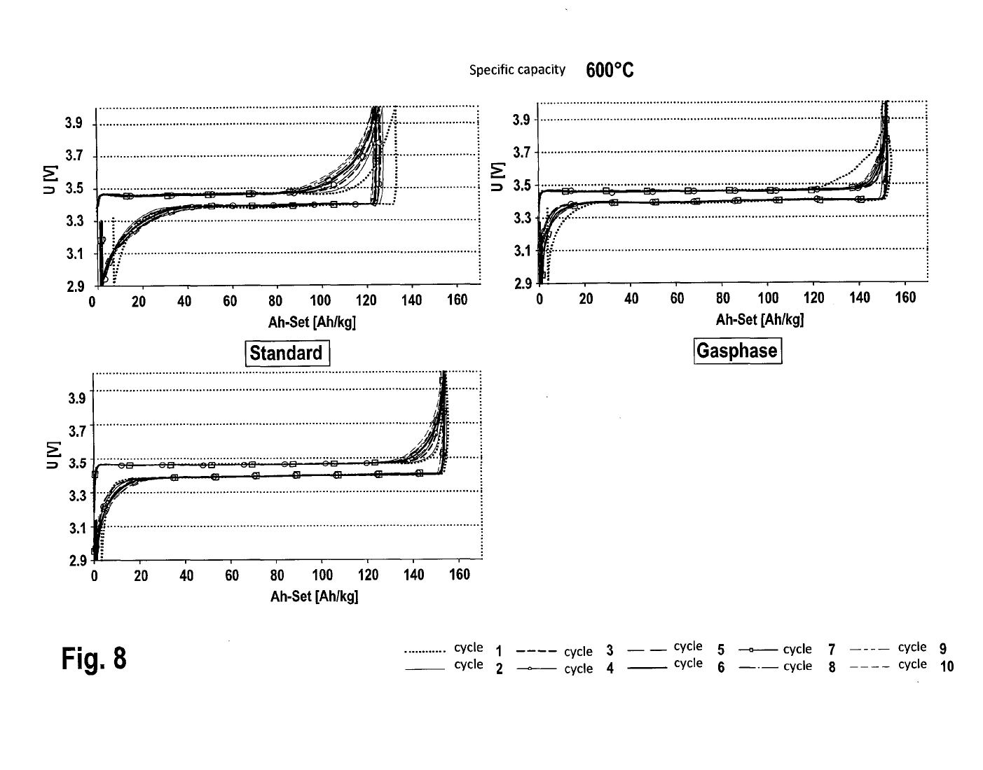

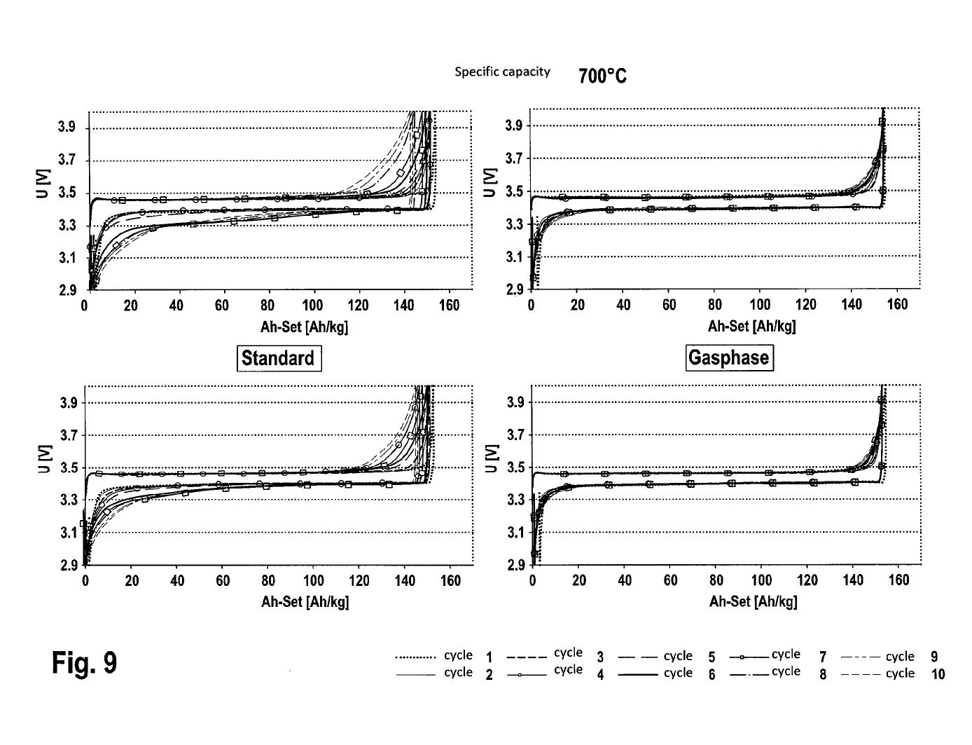

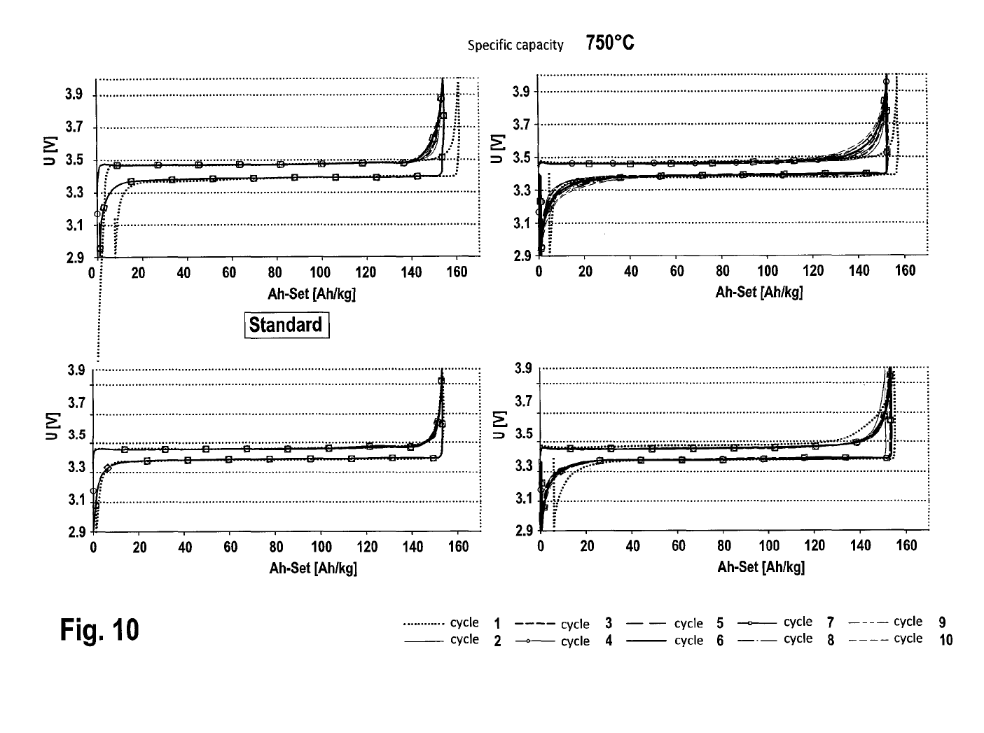

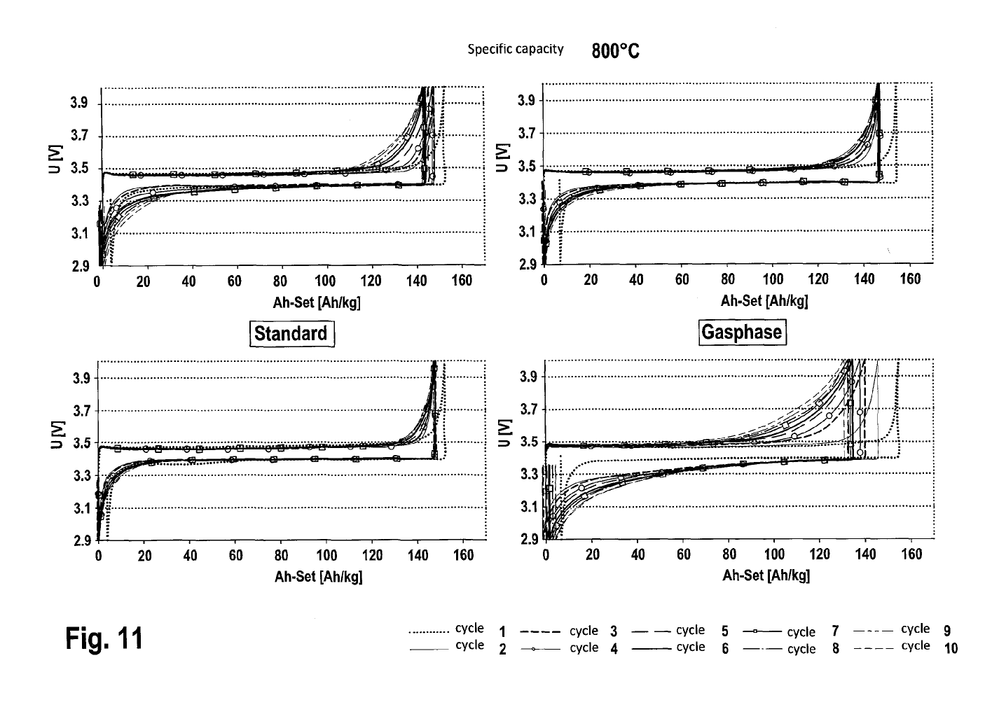

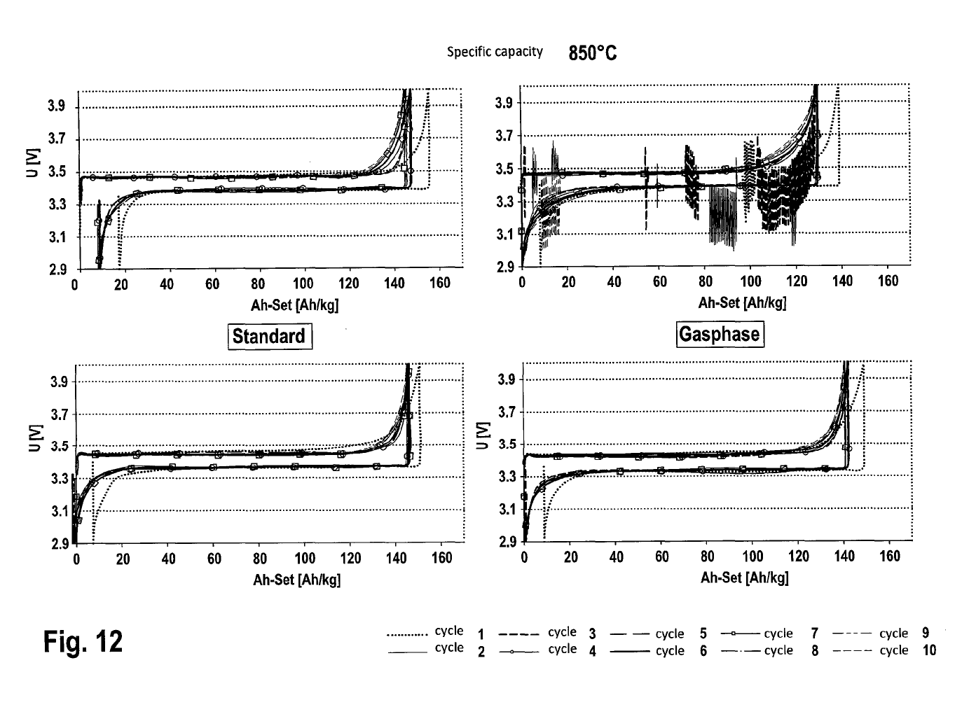

FIGS. 5 to 12 the specific capacity of carbon coated LiFePO₄ according to the invention in comparison to carbon coated LiFePO₄ of prior art,

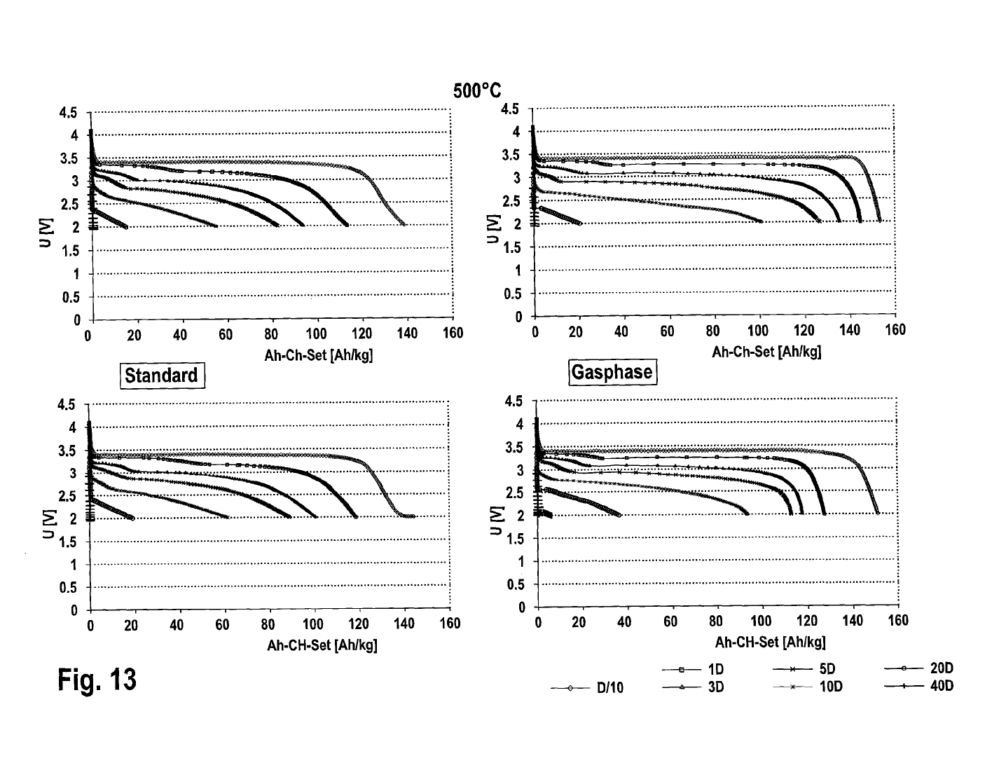

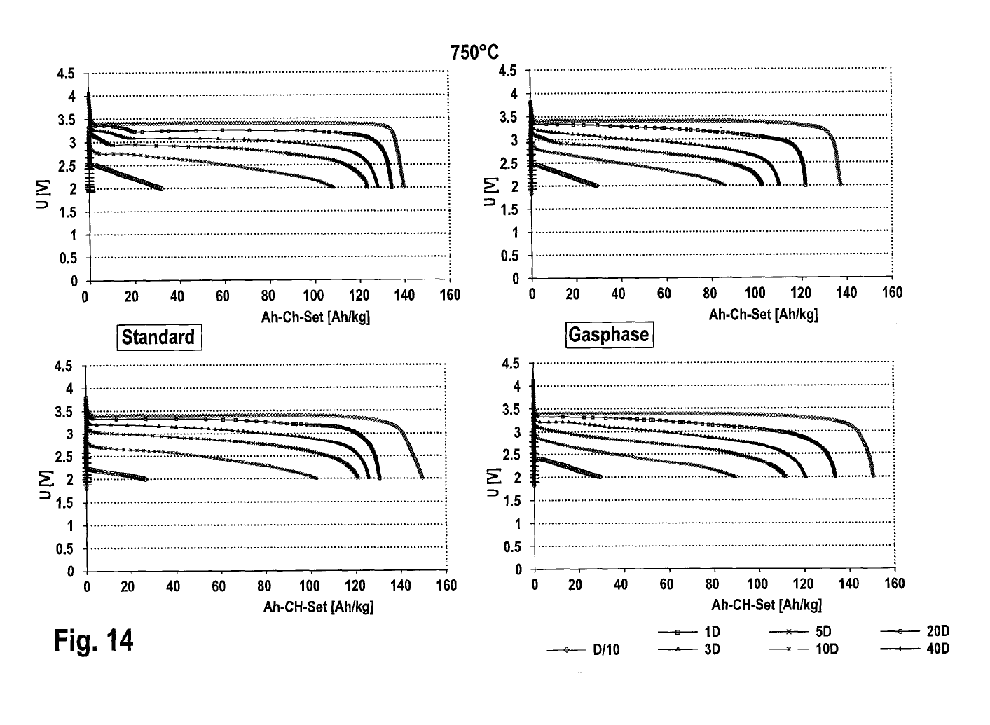

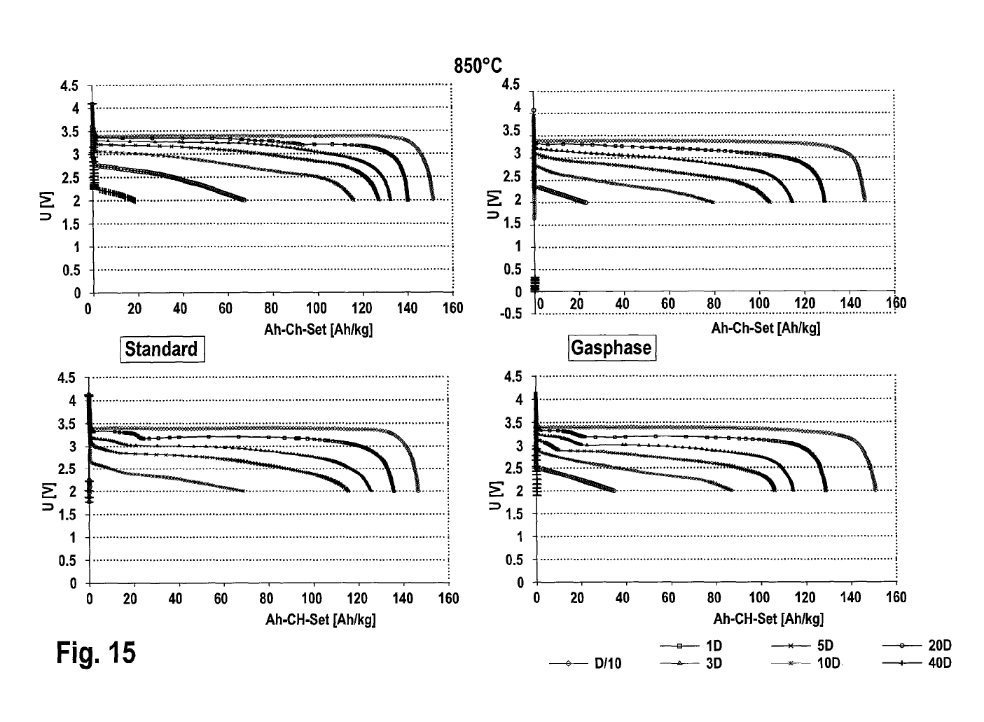

FIGS. 13 to 15 the discharge capacity of LiFePO₄ according to the invention at different current rates in comparison to carbon coated LiFePO₄ of prior art,

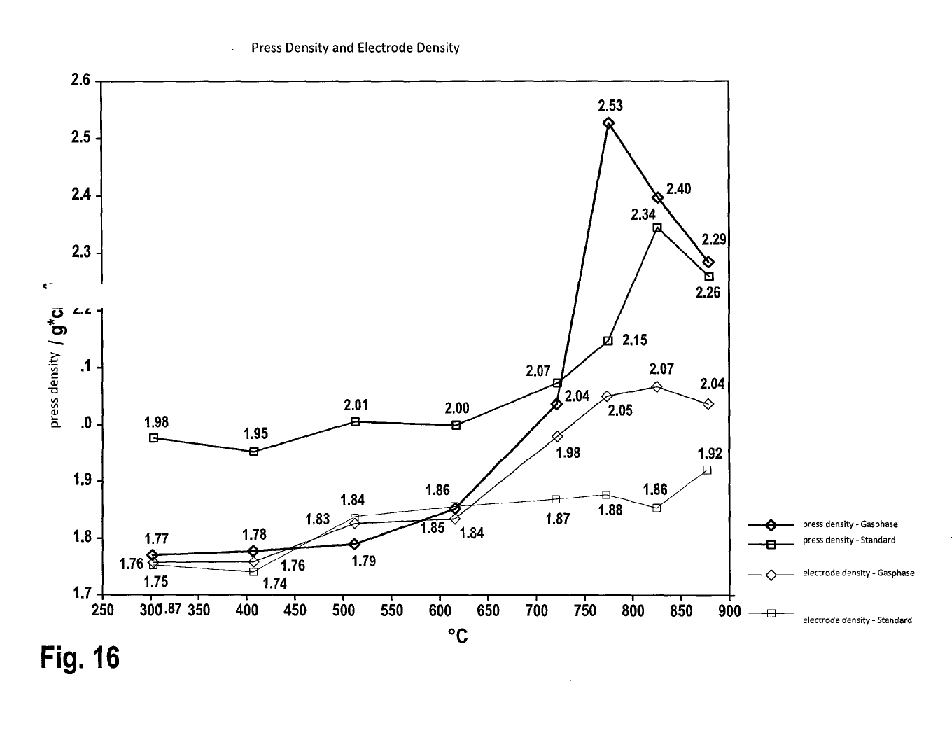

FIG. 16 the correlation between the powder press density and the electrode density of carbon coated LiFePO₄ according to the invention in comparison to carbon coated LiFePO₄ of prior art,

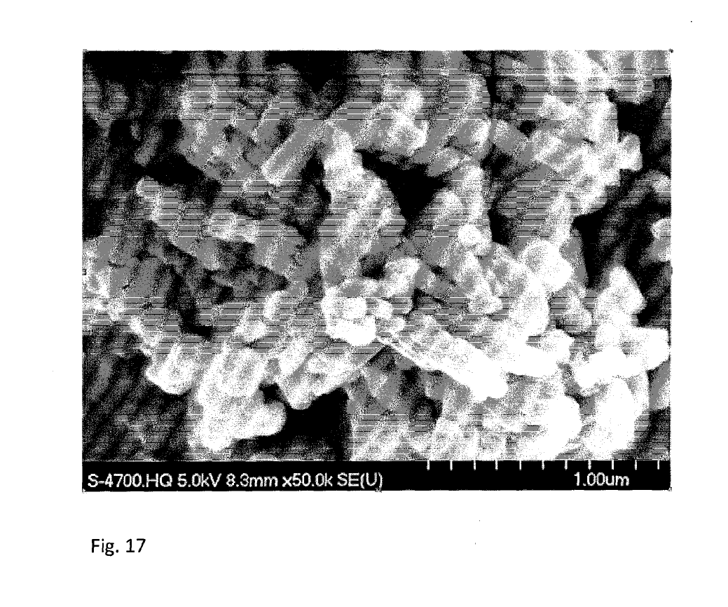

FIG. 17 the SEM image of hydrothermally produced LiFePO₄,

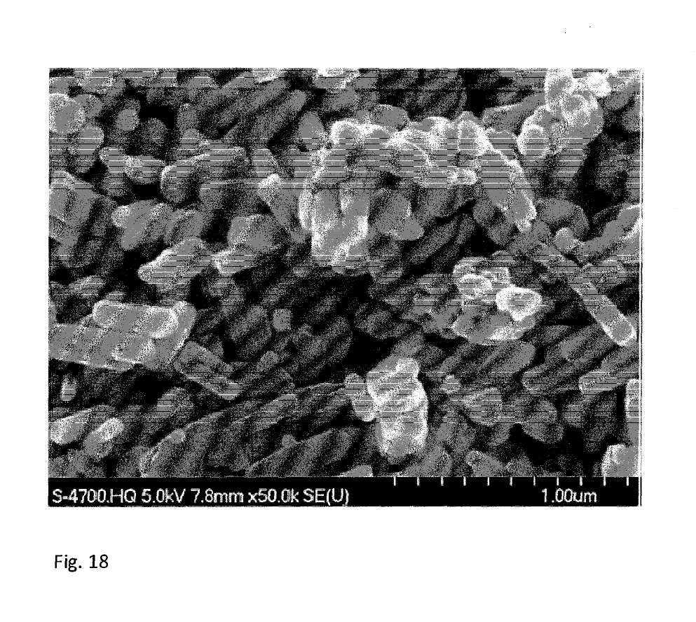

FIG. 18 the SEM image of LiFePO₄ coated with a layer of carbonaceous material according to the invention,

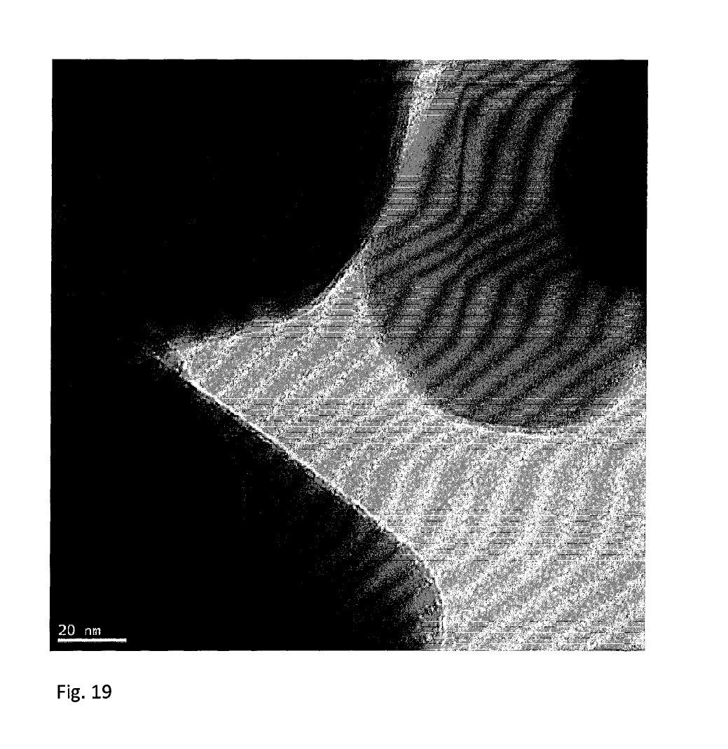

FIG. 19 the TEM image of a carbonaceous layer according to invention,

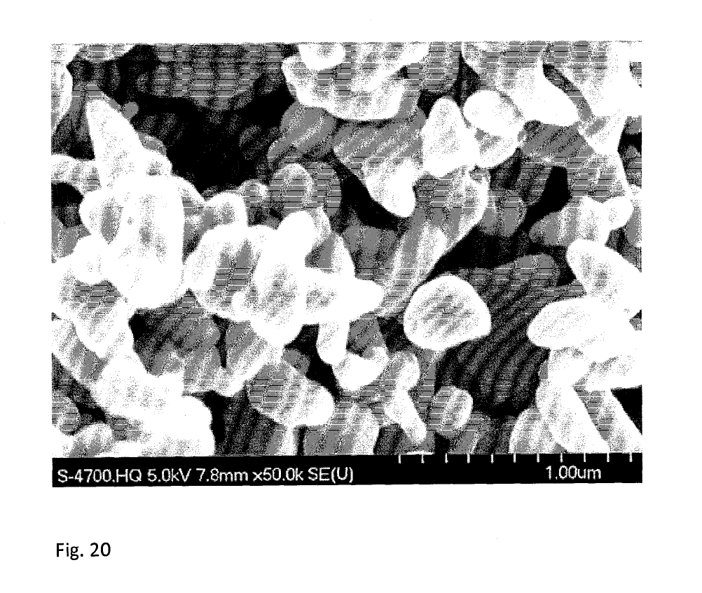

FIG. 20 the SEM image of carbon coated LiFePO₄ according to the invention,

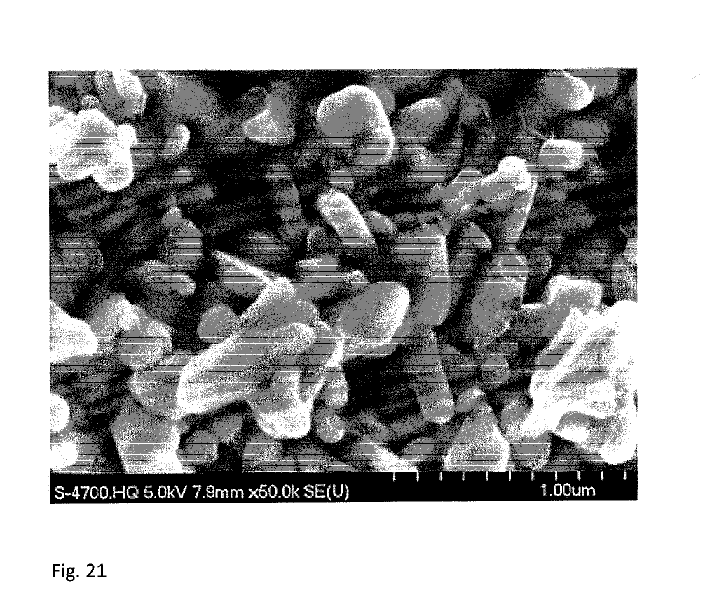

FIG. 21 the SEM image of comparative example 1,

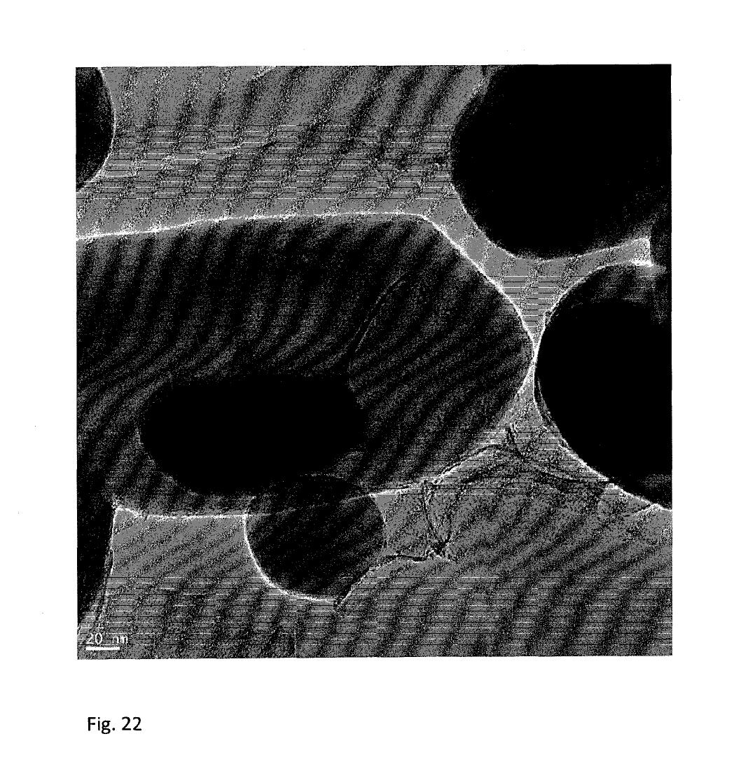

FIG. 22 the TEM image of comparative example 1,

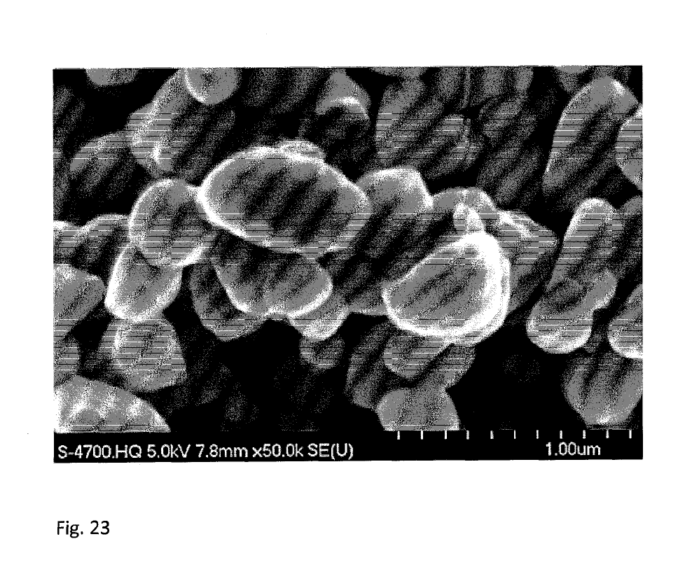

FIG. 23 the SEM image of comparative example 2,

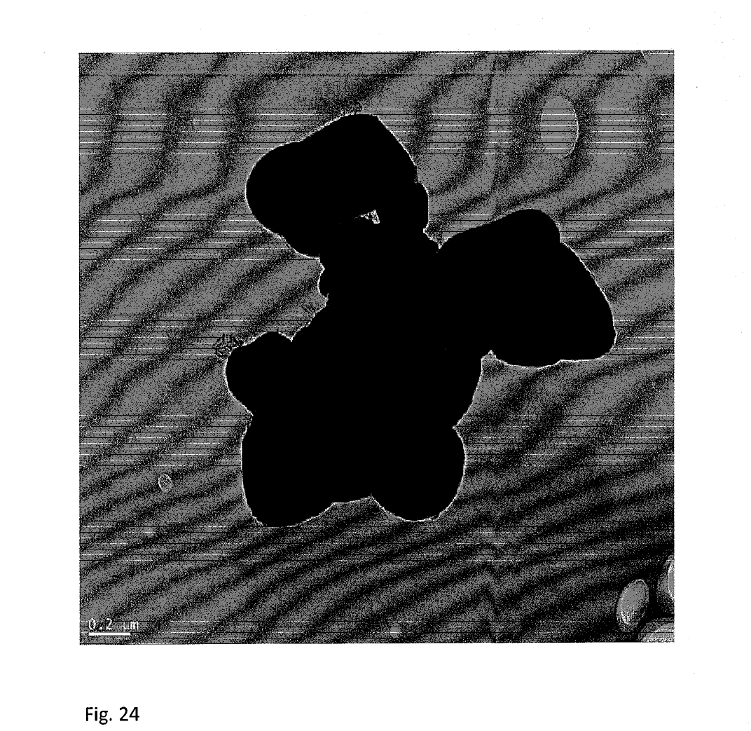

FIG. 24 the TEM image of comparative example 2,

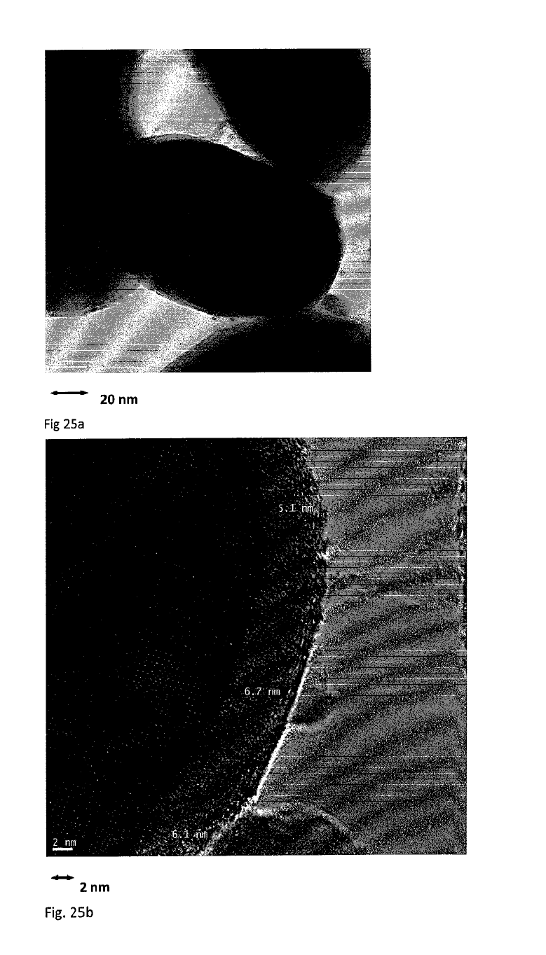

FIG. 25 the TEM image of example 5 sample 3b

### 1. METHODS

The determination of the BET surface was carried according to DIN ISO 9277.

The determination of the particle size distribution was carried out by laser granulometry with a Malvern Mastersizer 2000 apparatus according to ISO 13320.

Carbon measurements were carried out as so-called LECO measurements with a Leco CR12 carbon analyzer from LECO Corp., St. Joseph, Mich., USA or on a C/S analyzer ELTRA CS2000 (ELTRA measurements)

Sulfur measurements were carried out on a C/S analyzer ELTRA CS2000.

TEM measurements were carried out with a Hitachi S-4700 apparatus.

X-Ray diffraction (XRD) measurements were carried out on a Philips X'pert PW 3050 instrument with CuK_{α} radiation (30 kV, 30 mA) with a graphite monochromator and a variable slit. Upon measurement of the electrode foils (substrate+particle coating), the foils are arranged tangential and flat with respect to the focussing circle according to the Bragg-Brentano condition.

The determination of the press density and powder resistivity was carried out simultaneously with a Mitsubishi MCP-PD51 tablet press apparatus with a Loresta-GP MCP-T610 resistivity measurement apparatus which is installed in a glovebox under nitrogen to avoid potential disturbing effects of oxygen and humidity. The hydraulic operation of the tablet press was carried out with a manual hydraulic press Enerpac PN80-APJ (max. 10,000 psi/700 bar).

The measurements of a sample according to the invention of 4 g were carried out with the settings as recommended by the manufacturer of the above-mentioned apparatuses.

The powder resistivity was calculated according to the following equation:

powder resistivity [Ω·cm]=resistivity [Ω]×thickness [cm]×RCF

The RCF value is a value depending on the apparatus and has been determined for each sample according to the recommendations of the manufacturer.

The press density was calculated according to the following formula:

$$press density ( g \text{/} {cm}^{3} ) = \frac{mass of sample ( g )}{Π \times {r}^{2} ( {cm}^{2} ) \times thickness of sample ( in cm )}$$

$$r = radius of the sample pill$$

Usual deviations are about 3%.

The carbon coating of the comparative prior art examples according to EP 1 049 182 B1 were carried according to example 3 of EP 1049 182 B1 with the modification that instead of sucrose, α-lactose monohydrate was used in corresponding amounts.

### 2. EXAMPLES

### Example 1

LiFePO₄ was synthesized by hydrothermal reaction using the process described in WO 05/051840 (also commercially obtainable by Süd-Chemie AG). The SEM image of the as-received materials is given in FIG. 17 showing some aggregates of nanosized primary particles. The LiFePO₄ powder was put into a zirconia crucible and then placed in a sealed stainless steel case with a gas inlet and a gas outlet. Beside the LiFePO₄ crucible, another zirconia crucible containing Unithox U550 polymer was placed in the same steel case. The sealed steel case is flushed with argon for one hour before heating. After that the material is heated to 400° C. at a heating rate of 6° C./minute and held for 2 hours under the protection of argon flow, followed by furnace cooling. LECO measurements with a Leco CR12 carbon analyzer from LECO Corp., St. Joseph, Mich., USA give 2.38 wt % of carbon.

SEM analyses show no obvious change of particle morphology. The aggregates of the primary particles are shown in FIG. 18. There is no excess of carbonaceous materials accumulated on the particle surface. As shown in the TEM picture of FIG. 19, a thin layer of carbonaceous material with a thickness of about 2 nm was coated on the surface of LiFePO₄ particles, and the thickness of the coating is very homogeneous. Low magnification of TEM observation did not show accumulated carbon.

### Example 2

The organic carbonaceous coating in the gas phase at 400° C. was performed as described in example 1. Following that, the lithium metal phosphate materials coated with carbonaceous species are further carbonized at 700° C. for 1 h under the protection of argon flow. FIG. 20 shows the SEM image of the carbon coated materials. No obvious excess of carbon was found on the particle surface. No obvious sintering of particle was observed. But TEM observation shows a homogeneous thin layer of carbon on the particle surface. LECO measurement gives a carbon content of 1.3 wt %. The thickness of the carbon coating layer can be precisely controlled by adjusting the concentration of the low molecular weight material in the gas stream or the gas exposure time of lithium metal phosphate in the first organic coating step.

### Comparative Example 1

In this comparative example, the same source of LiFePO₄ material was coated with carbon by using the method being described in the U.S. Pat. No. 6,855,273 and U.S. Pat. No. 6,962,666 (corresponds to EP 1 049 182 B1). 10 wt % of lactose was added to LiFePO₄ via a process of dissolving the lactose in water and then making a LiFePO₄ and lactose in water slurry followed by drying. Carbonization was also performed in the same steel case in a box furnace. The lactose coated LiFePO₄ was flushed with argon for 1 h and then heated to 700° C. at a heating rate of 6° C./min and then held for 1 h under the protection of argon flow. LECO measurement gives 2.2 wt % of carbon of the furnace cooled black powder. SEM analysis has shown that a lot of excess of carbon are accumulated on some area of the particle surface as shown in FIG. 21. TEM observation indicates that most of the particles are wrapped with carbon layer as shown in FIG. 22.

The carbon layer on the particle surface is not of the same thickness. Some surface area is coated with very thick carbon layer, while some surface areas are coated with very thin carbon layer. In some region, no clear carbon coating is found.

### Comparative Example 2

In this comparative example, the same source of LiFePO₄ material was coated through gas phase reaction. 1 g of LiFePO₄ powder was flushed with argon for 1 hour and then continuously flushed with a mixture of 50% argon and 50% natural gas for 10 minutes. After that the powder is heated to 400° C. at a heating rate of 6° C./min and held at 400° C. for 2 h in the presence of the same mixture gas. Following that, the material was heated to 700° C. for 1 h treatment in the same gas atmosphere in a final step.

FIG. 23 shows the SEM picture of the carbon coated materials obtained in the gas phase carbon coating. It can be seen that LiFePO₄ particles are sintered to large aggregates. TEM observation also shows that the particles are severely sintered together. It is also obvious that large carbon clusters can grow on the LiFePO₄ particle surface even in the gas phase (see FIG. 24). The LECO measurement gave a carbon content of 0.24 wt %.

### Example 3

Synthesis of Carbon Coated LiFePO₄ In Situ Starting From FePO₄

a) Synthesis of LiFePO₄:

A ceramic tube that had 2 compartments one on top of the other separated by a ceramic sieve (filter). The upper compartment contained a stoichiometric mixture of FePO₄×2H₂O and Li₂CO₃ totaling 95 wt % and the lower compartment contained 5 wt % Unithox 550 pellets. The amount of polymer was slightly higher than in Example 1 (3.6 to 4.5 wt % polymer) because some of the gases generated from pyrolysis could escape under the tube and avoid the solids in the upper compartment. The tube was placed in a ceramic crucible that carried a loosely fitting lid so that the pyrolysis gases would not quickly escape from the reactor and would avoid a pressure build-up.

The crucible was placed in a furnace under an inert nitrogen atmosphere. The crucible was heated to 400° C., maintained at 400° C. for 2 hours and then cooled to room temperature. The solid products in the upper compartment are then subjected to XRD analysis, specifically to measure the product(s). Pure LiFePO₄ was obtained together with small amounts of FePO₄ and Li₄P₂O₇.

b) Carbon Coating

b.1) In Situ Coating

Using 8 wt % Unithox pellets in step a) instead of 5 wt % yielded directly a product with a carbon coating and a carbon content of 0.9 wt % (ELTRA measurements)

b.2) Subsequent Coating

The carbon coating of the pure LiFePO₄ obtained in step a) was carried out as in examples 1 and 2. The carbon content of the product was as in example 2 (LECO and ELTRA measurements)

### Example 4

Coating in the Fluid-Bed Phase

Hydrothermally obtained LiFePO₄ (commercially obtainable from Süd-Chemie AG) was fluidized in a stream of N₂ gas in a fluidized bed reactor at a temperature of 400° C. α-lactose monohydrate was decomposed in a separate vessel. The decomposition products were mixed with the stream of fluidization gas (N₂) while heating the fluidized bed reactor up to 750° C. After 1 hour, a carbon coating was deposited. The obtained material showed properties similar to sample 3b below:

| | |
|---|---|
| D₁₀ | 0.21 μm |
| D₅₀ | 0.70 μm |
| D₉₀ | 2.48 μm |

BET surface area: 10 m2/g

Press density: 2.44 g/cm3

Powder resistivity: 3 Ω·cm

Carbon content: 0.84 wt % (ELTRA)

Sulfur content: 0.05 wt %

Specific capacity (measured at C/12): 152 mAh/g

### Example 5

Temperature Variation in Carbon-Coating According to the Invention and According to EP 1 049 182 B at Temperatures From 300 to 850° C.

8 samples of particulate LiFePO₄ (commercially obtainable by Süd-Chemie AG, synthesized hydrothermally) were placed in eight different crucibles. Also, α-lactose monohydrate was placed in 8 crucibles. For each run, a crucible with LiFePO₄ and one with alpha-lactose monohydrate were placed in a furnace separated from each other. Both crucibles were heated in the furnace for each run at different temperatures from 300 to 850° C. The crucible with LiFePO₄ was heated at lower temperatures (ca. 50° C. lower) than the crucible with alpha-lactose monohydrate.

The lactose compound decomposed at each temperature forming a gas phase containing the pyrolysis product of lactose resulting as described beforehand in carbon-coated LiFePO₄ particles (carbon content was measured by ELTRA). FIG. 25a is the TEM image of sample 3b, showing a homogeneous carbon coating around the lithium transition metal phosphate particles. FIG. 25b is the enlarged TEM image from FIG. 25a, sowing the homogeneitiy of the carbon layer of the coating with a very small variation in thickness, varying from 6.7 to 5.1 nm.

Table 1 shows an overview over the different runs:

TABLE 1
Carbon coating according to the invention carried
out at different temperatures.

| | Standard Coating | Gasphase-coating |
|---|---|---|
| | according to EP 1 049 | according to the |
| Temperature | 182 B1 (Example 3) | invention |
| [° C.] | Sample Nr. | Sample Nr. |
| 300 | 8a | 8b |
| 400 | 7a | 7b |
| 500 | 6a | 6b |
| 600 | 5a | 5b |
| 700 | 4a | 4b |
| 750 | 3a | 3b |
| 800 | 2a | 2b |
| 850 | 1a | 1b |

FIG. 1 shows an overview of the particle size distribution (D₁₀, D₅₀, D₉₀) of the samples mentioned in table 1 of LiFePO₄ coated according to the invention compared to LiFePO₄ coated according to example 3 of EP 1 049 182 B1 (also with lactose monohydrate) dependent of the pyrolysis temperature from 300 to 850° C. The D₉₀ values of the particle size distribution of the LiFePO₄ manufactured according to the invention are varying in the range of 1.29 (sample 8b, 300° C. pyrolysis temperature) to 2.63 μm (sample 3b, 750° C. pyrolysis temperature). The D₉₀ values of a carbon coated LiFePO₄ manufactured according to example 3 of EP 1 049 182 B1 are however markedly higher (5.81 of sample 1a to 14.07 μm of sample 7a). The D₅₀ values of the LiFePO₄ according to the invention are varying in the range of 0.39 (sample 8b, 300° C. pyrolysis temperature) to 0.81 (sample 2b, 800° C. pyrolysis temperature). The D₅₀ values of carbon coated LiFePO₄ manufactured according to example 3 of EP 1 049 182 B1 however are varying in the range of 0.33 (sample 8a, 300° C. pyrolysis temperature) to 0.48 (sample 1a, 850° C. pyrolysis temperature). The D₁₀ values of the LiFePO₄ according to the invention are however in the range of 0.19 (sample 8b) to 0.22 (sample 3b and 1b) whereas the D₁₀ values of carbon coated LiFePO₄ according to example 3 of EP 1 049 182 B1 are in the range of 0.17 (sample 8a) to 0.20 μm (sample 1a). In this context it is notable that the D₉₀ value for the LiFePO₄ according to the invention is markedly lower than the D₉₀ value of carbon coated LiFePO₄ obtained according to example 3 of EP 1 049 182 B1 for all temperatures.

FIG. 2 shows that the BET surface of the LiFePO₄ coated according to the invention (from 7.7 m²/g for sample 1b to 13 m²/g for sample 8b) compared to a carbon coated LiFePO₄ according to example 3 of EP 1 049 182 B1 (from 15.4 m²/g for sample 1a to 21 m²/g for sample 5a and 6a) is markedly smaller. The smaller BET surface provides higher press densities and therefore an increased electrode density. Therefore, also the capacity of a battery can be increased upon using the LiFePO₄ according to the invention as active material in an electrode.

FIG. 3 shows a correlation diagram between the powder press density and the powder resistivity of a LiFePO₄ coated according to the invention compared to a carbon coated LiFePO₄ coated according to example 3 of EP 1 049 182 B1 each manufactured at the temperatures mentioned in table 1 in temperature range of 300 to 850° C. The powder press density of the material coated according to the invention increases from 300° C. (sample 8b) to reach a maximum at 750° C. (sample 3b) of about 2.53 g/cm³. Only then, at higher temperatures, the powder press density decreases to 2.29 g/cm³ (sample 1b). The powder resistivity has been measured for the material according to the invention only starting at 500° C. (sample 6b) and is decreasing in the range from 500 to 750° C. (sample 3b) to a minimum of about 2 Ω·cm to increase in the next range up to 850° C. (sample 1b) to a maximum of 25 Ω·cm. The correlation between powder press density and powder resistivity, wherein at 750° C. a maximum of the press density and a minimum of the powder resistivity is obtained is clearly seen. The powder press density of carbon coated LiFePO₄ according to example 3 of EP 1 049 182 B1 is higher in the temperature range of 300 to 600° C. (sample 8a to sample 5a) and is at 700° C. (sample 4a) more or less equal to the material according to the invention (sample 4b at 700° C.). However, at temperatures>700° C. it does not match the values of the material according to the invention. Therefore, also the powder resistivity of the material coated according to EP 1 049 182 B1 is markedly higher than for the material according to the invention and has its minimum of 9 Ω·cm at a temperature of 850° C. (sample 1b).

FIG. 4 shows the carbon content and the sulfur content of the samples from table 1. The material manufactured according to the invention has low carbon contents in the range of 0.66 (sample 1b) to a maximum of 0.93 (sample 5b), wherein carbon coated LiFePO₄ according to example 3 of EP 1 049 182 B1 has a carbon content from more than 2 wt % (sample 1a 2.25 wt % to sample 8a, 293 wt %). Through the use of the precursor compound α-lactose monohydrate for pyrolysis and gas phase coating, a very low sulfur content is obtained for carbon coated LiFePO₄ according to the invention, the lowest values obtained in the temperature range from 600° C. (sample 5b, 0.09 wt %) to 850° C. (sample 1b, 0.03 wt %) compared to values of 0.09 wt % (sample 5a) to 0.07 wt % (sample 1a) for prior art carbon coated LiFePO₄. The low sulfur content is correlated to an increase in electrical conductivity of the material according to the invention.

The LiFePO₄ obtained according to the invention is nearly phase pure. In XRD measurements neither crystalline Fe₂P nor other impurity phases of impurities besides small amounts of Li₃PO₄ and Li₄P₂O₇ have been found even in the samples manufactured at 850° C. Therefore, it can be assumed that LiFePO₄ coated via the gas phase according to the invention is stable against reduction even at higher temperatures.

The specific capacity (see FIGS. 5 to 12) of carbon coated LiFePO₄ according to the invention is at temperatures from 400° C. typically around 150 mAh/g. Samples which have been coated in a temperature range of 500 to 750° C. have capacities of more than 150 mAh/g. LiFePO₄ with carbon coating (manufactured according to example 3 of EP 1 049 182 B1) at show however inferior values. The LiFePO₄ manufactured according to the invention has further very good discharge rates (see FIGS. 13 to 15).

### Example 6

### Preparation of Electrodes

The standard electrode compositions (formulations) contained 85 wt % active material (i.e. carbon coated transition metal phosphate according to the invention), 10 wt % super P carbon black and 5 wt % PVdF (polyvinylidenedifluoride).

Slurries were prepared wherein first a 10 wt % PVdF 21216 solution in NMP (N-methylpyrrolidone) with a conductive additive (super P carbon black) was prepared which was further diluted with NMP before adding the corresponding active material. The resulting viscous suspension was coated on an aluminum foil by doctor blading. The coated aluminum foil was dried under vacuum at 80° C. From this foils, circles with a diameter of 1.3 cm were cut out, weighed and pressed between two aluminum foils 4 times for 1 minute at 8 t pressure with a hydraulic press. The thickness and density of the electrodes were measured. The electrodes were then dried under vacuum at 130° C. over night in a Büchi drying oven.

The above-mentioned method comprised multiple pressing of the electrode material at high pressures to generate comparable results. According to the above-mentioned method, values for the electrode density with carbon coated LiFePO₄ as active material were measured in the range of 2.04 to 2.07 g/cm³ at maximum (see FIG. 16). These values were obtained especially with samples which have been manufactured at 750 to 850° C. Without being bound to a specific theory, these findings allow the conclusion that a combination of gas phase coating according to the invention in combination with a relatively low carbon content might be the reason for the high electrode densities observed for the electrodes according to the invention.

1. Particulate lithium transition metal phosphate with a homogeneous carbon coating deposited from a gas phase comprising pyrolysis products of a carbon containing compound.

2. Lithium transition metal phosphate according to claim 1 with formula (1)
LiM′_{y}M″ₓPO₄ (1)
wherein M″ is at least one transition metal selected from the group Fe, Co, Ni and Mn, M′ is different from M″ and represents at least a metal, selected from the group consisting of Co, Ni, Mn, Fe, Nb, Ti, Ru, Zr, B, Mg, Zn, Ca, Cu, Cr or combinations thereof, 0<x≦1 and wherein 0≦y<1 or
formula (2)
LiFeₓMn_{1-x-y}M_{y}PO₄ (2)
wherein M is a metal with valency +II of the group Sn, Pb, Zn, Mg, Ca, Sr, Ba, Co, Ti and Cd and wherein x<1, y<0.3 and x+y<1.

3. Lithium transition metal phosphate according to claim 2 with a carbon content of less than 2.5 wt %.

4. Lithium transition metal phosphate according to claim 3 with a powder press density of ≧1.5 g/cm³.

5. Lithium transition metal phosphate according to claim 4 with a sulfur content of 0.01 to 0.15 wt %.

6. Lithium transition metal phosphate according to claim 5 with a powder density of 10 Ω·cm.

7. Lithium transition metal phosphate according to claim 6 whose particles have a spherical morphology.

8. Lithium transition metal phosphate according to claim 7 wherein the particles have a length/width ratio of 0.7 to 1.3.

9. Lithium transition metal phosphate according to claim 8 with a BET surface of ≦11 m²/g.

10. Process for the manufacturing a lithium transition metal phosphate according to claim 1 comprising the steps of:
a) providing a particulate lithium transition metal phosphate or its precursor compounds,
b) deposition of a carbon containing coating on the lithium transition metal phosphate particles or the particles of a precursor compounds by exposing the particles to an atmosphere which comprises pyrolysis products of a carbon containing compound,
c) carbonizing of the carbon containing coating.

11. Process according to claim 10 wherein the lithium transition metal phosphate is represented by formula (1)
LiM′_{y}M″ₓPO₄ (1)
wherein M″ is at least one transition metal selected from the group Fe, Co, Ni and Mn, M′ is different from M″ and represents at least a metal, selected from the group consisting of Co, Ni, Mn, Fe, Nb, Ti, Ru, Zr, B, Mg, Zn, Ca, Cu, Cr or combinations thereof, 0<x≦1 and wherein 0≦y<1
or
formula (2)
LiFeₓMn_{1-x-y}M_{y}PO₄ (2)
wherein M is a metal with valency II of the group Sn, Pb, Zn, Mg, Ca, Sr, Ba, Co, Ti and Cd and wherein x<1, y<0.3 and x+y<1.

12. Process according to claim 11 wherein as carbon containing compound a carbohydrate or a polymer is used.

13. Process according to claim 12 wherein the pyrolysis of the carbon containing compound is carried out at a temperature of from 300 to 850° C.

14. Process according to claim 13 wherein the deposition of the coating is carried out at a temperature of from 300 to 850° C.

15. Process according to claim 14 wherein the particles of the lithium transition metal phosphate or its precursor compounds have a lower temperature as the atmosphere comprising the pyrolysis products.

16. Process according to claim 14 wherein the deposition of the coating on the particles of the lithium transition metal phosphate is carried out in a fluid bed.

17. Carbon coated particulate lithium transition metal phosphate obtainable according to a process of claim 10.

18. Electrode for a secondary lithium ion battery comprising a lithium transition metal phosphate according to claim 1 as active material.

19. Electrode according to claim 18 with an electrode density of 1.5 to 2.6 g/cm³.

20. Secondary lithium ion battery containing an electrode according to claims 18.
